(19) United States
(12) Patent Application Publication
(10) Pub. No.: US 2024/0425947 A1
(43) Pub. Date: Dec. 26, 2024

(54) ELECTRIFIED LIQUID-LIQUID EXTRACTION SYSTEM FOR SELECTIVE EXTRACTION OF PRECIOUS METAL SPECIES

(71) Applicant: THE BOARD OF TRUSTEES OF THE UNIVERSITY OF ILLINOIS, Urbana, IL (US)

(72) Inventors: Xiao Su, Urbana, IL (US); Stephen Cotty, Champaign, IL (US); Aderiyike Faniyan, Champaign, IL (US); Johannes Elbert, Urbana, IL (US)

(73) Assignee: THE BOARD OF TRUSTEES OF THE UNIVERSITY OF ILLINOIS, Urbana, IL (US)

(21) Appl. No.: 18/739,942

(22) Filed: Jun. 11, 2024

Related U.S. Application Data
(60) Provisional application No. 63/472,762, filed on Jun. 13, 2023.

(51) Int. Cl. C22B 3/26; C22B 3/02; C22B 3/42; C22B 7/00; C22B 11/00

(52) U.S. Cl. CPC C22B 3/26; C22B 3/02; C22B 3/42; C22B 7/006; C22B 11/046

(57) ABSTRACT

Electrified liquid-liquid extraction systems including an alkyl-substituted ferrocene compound as an organic adsorbent are provided herein. Methods of recovering a metal from a leach solution are further provided.

### CROSS-REFERENCE TO RELATED APPLICATIONS

The present application claims the benefit of U.S. Provisional Application No. 63/472,762, filed Jun. 13, 2023, the entirety of which is incorporated by reference herein for all purposes.

### STATEMENT REGARDING FEDERALLY FUNDED RESEARCH

This invention was made with government support under contract number DE-SC0021409 awarded by the Department of Energy. The government has certain rights in the invention.

### TECHNICAL FIELD

The present disclosure relates to extraction systems.

### BACKGROUND

Increasing demand for renewable energy technologies will require sustainable supplies of precious metals such as gold, platinum, palladium, and iridium. Traditional mining and recycling processes for the precious metals may contribute to environmental damage, lack selectivity, inefficiently consume energy, and escalate costs. Though liquid-liquid extraction (“LLE”) has been applied in conventional industrial processes for metal extraction, conventional LLE has suffered from low selectivity, poor up-concentration, and inefficient release of target materials.

There is a need for LLE systems that selectively and efficiently recover precious metals from dilute, contaminated metal leach solutions. Further, there is a need for more efficient methods of precious metal recovery that minimize pollution, maintain a circular economy of precious materials, enhance recovery performance, and reduce energy and material consumption.

### SUMMARY

In an example, the present disclosure provides an electrified liquid-liquid extraction system, including: an organic adsorbent loop, through which flows a solution of an alkyl-substituted ferrocene compound in an organic solvent, the organic adsorbent loop including, in a direction of flow of the solution, an oxidation solvent extraction column, a leach solvent extraction column, and a reduction solvent extraction column; an aqueous oxidant loop, through which flows an aqueous oxidant solution including an oxidizing agent, the aqueous oxidant loop including, in a direction of flow of the aqueous solution of the oxidizing agent, the oxidation solvent extraction column and an anode of a flow cell; an aqueous reductant loop, through which flows an aqueous reductant solution including a reducing agent, the aqueous reductant loop including, in a direction of flow of the aqueous solution of the reducing agent, the reduction solvent extraction column and a cathode of the flow cell; a leach stream loop, through which flows a leach solution, the leach stream loop including the leach solvent extraction column; and the flow cell, including an ion exchange membrane between the cathode and the anode.

In another example, the present disclosure provides a method of recovering a metal from a leach solution, including: cycling a solution of an alkyl-substituted ferrocene compound in an organic solvent sequentially through an oxidation solvent extraction column, a leach solvent extraction column, and a reduction solvent extraction column in an organic adsorbent loop; oxidizing the alkyl-substituted ferrocene compound in the oxidation solvent extraction column to provide an oxidized alkyl-substituted ferrocene compound; adsorbing an anionic species of the metal from the leach solution to the oxidized alkyl-substituted ferrocene compound in the leach solvent extraction column to provide a complex of the anionic species and the oxidized alkyl-substituted ferrocene compound; and reducing the oxidized alkyl-substituted ferrocene compound to provide the alkyl-substituted ferrocene compound in the reduction solvent extraction column, the anionic species transferred to an aqueous reductant solution in the reduction solvent extraction column.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the present disclosure may be well understood, there will now be described various forms thereof, given by way of example, reference being made to the accompanying drawings. The components in the figures are not necessarily to scale.

FIG. 1 illustrates a schematic of an example of an electrified liquid-liquid extraction system according to the principles of the present disclosure;

FIG. 2 illustrates a bar graph comparing control extraction experiments using dichloromethane as organic phase solvents for the recovery of each of gold (Au), silver (Ag), and copper (Cu) metal, reversible metal recovery measured as the percentage of metal released divided by initial metal mass;

FIG. 3 illustrates a rendering of oxidized 1,1′-didodecylferrocene (“ddFc+”) binding to dicyanoaurate anion;

FIG. 4 illustrates a bar graph demonstrating the percentage of ferrocene (“Fc”) species lost to aqueous phase when the ferrocene species is oxidized as hydrophobic substituents increase in length;

FIG. 5 illustrates a bar graph demonstrating recovery efficiency of gold for various aqueous reducing agents;

FIG. 6 illustrates a plot of cyclic voltammograms at a scan rate of 10 mV/s with carbon felt working and counter electrodes, and a leakless Ag/AgCl reference electrode, for solutions containing: sodium ferrocyanide (10 mM aqueous); sodium iodide (10 mM aqueous); and ddFc (10 mM dichloromethane) with tetrabutylammonium hexafluorophosphate (100 mM);

FIG. 7 illustrates a bar graph demonstrating gold uptake and release performance for various oxidizing agents;

FIG. 8 illustrates a plot of the molar utilization of ddFc as the molar ratio of aqueous triiodide oxidizing agent was increased (experimental data are diamond-shaped data points in X-Y scatter plot; Nernst model in dashed line);

FIG. 9 illustrates a plot of the gold recovery efficiency of gold adsorbed with ddFc oxidized with equimolar nitrosonium tetrafluoroborate (NOBF₄) as the molar ratio of aqueous ferrocyanide reducing agent was increased (experimental data are diamond-shaped data points in X-Y scatter plot; Nernst model in dashed line);

FIG. 10 illustrates a plot of ddFc adsorption isotherms for gold, silver, and copper (experimental data are diamond-shaped data points in X-Y scatter plot; Langmuir isotherm model in dashed lines);

FIG. 11 illustrates a plot of gold recovery efficiency as a factor of up-concentration ratio, set by decreasing the volume:volume ratio of aqueous reducing solution to leach solution;

FIG. 12 illustrates a plot demonstrating the results of a ddFc cyclability study in which ddFc in DCM solution was recycled through up to 10 consecutive adsorption and release cycles;

FIG. 13 illustrates comparative UV-VIS spectra of the organic extractant solution including 2 mM ddFc in dichloromethane before oxidation, after oxidation and adsorption, and after reduction and desorption;

FIG. 14 illustrates a bar graph demonstrating an uptake and release performance of ddFc extraction with H₂PtCl₆, Na₃IrCl₆, H₂IrCl₆, and Na₃RhCl₆;

FIG. 15 illustrates a plot demonstrating uptake and gold performance kinetics for an example of an electrified liquid-liquid extraction system according to the principles of the present disclosure;

FIG. 16 illustrates a plot demonstrating energy consumption normalized by mass of gold that was recovered and cumulative charge over time for an example of an electrified liquid-liquid extraction system as the oxidizing agent and reducing agent were regenerated;

FIG. 17 illustrates a plot comparing initial metal purity of a gold leach solution from electronic waste (white circles) and final purity obtained after extraction (dark circles) using an example of an electrified liquid-liquid extraction system according to the principles of the present disclosure;

FIG. 18 illustrates a plot and bar graph demonstrating the initial leach concentration (plot) of an electronic waste leach solution and reversible uptake performance (bar graph) of extraction from the electronic waste leach solution using an example of an electrified liquid-liquid extraction system according to the principles of the present disclosure;

FIG. 19 illustrates a plot comparing initial metal purity of a gold leach solution from simulated mining ore (white circles) and final purity obtained after extraction (dark circles) using an example of an electrified liquid-liquid extraction system according to the principles of the present disclosure;

FIG. 20 illustrates a plot and bar graph demonstrating the initial leach concentration (plot) of a mining ore leach solution and reversible uptake performance (bar graph) of extraction from the mining ore leach solution using an example of an electrified liquid-liquid extraction system according to the principles of the present disclosure;

FIG. 21 illustrates a plot of cost breakdown of gold recovery over a range of gold feed concentrations by extraction using an example of an electrified liquid-liquid extraction system according to the principles of the present disclosure;

FIG. 22 illustrates a bar graph demonstrating a gold refinement cost comparison for three methods of gold recovery: activated carbon-based (“AC”) carbon in pulp (“CIP”) process; polyvinyl ferrocene carbon nanotube (“PVF-CNT”) electrosorption; and electrified liquid-liquid extraction using a ferrocene (Fc) species;

FIG. 23 illustrates a bar graph demonstrating a comparison of extraction with ddFc in various solvents (2 mM) using an example of an electrified liquid-liquid extraction system according to the principles of the present disclosure;

FIG. 24 illustrates a plot demonstrating a control experiment for determining the solubility of potassium dicyanoaurate over a range of aqueous gold concentrations for various pure organic solvents;

FIG. 25 illustrates a plot comparing the percentage of dicyanoaurate that migrates from aqueous to pure organic solvents as a function of the dielectric constants of the solvents;

FIG. 26 illustrates a bar graph demonstrating a control extraction experiment using pure organic solvents including no ferrocene species;

FIG. 27 illustrates a plot demonstrating gold uptake and recovery efficiency as a function of the molar ratio of NOBF₄ oxidant to ddFc;

FIG. 28 illustrates a plot demonstrating uptake and release of 5 mM gold in solutions ranging in pH, with HClO₄ added to the aqueous absorption solution for acidic solutions, and NaOH added to the aqueous absorption solution for basic solutions;

FIG. 29 illustrates a plot of gold adsorption isotherms, demonstrating molar utilization and gold removal percentage with increasing equilibrium gold concentrations;

FIG. 30 illustrates a plot of gold removal percentage versus logarithmic equilibrium gold concentration, divided into two regions: 1) ddFc in large excess relative to gold; 2) gold in excess relative to ddFc;

FIG. 31 illustrates a plot demonstrating a comparison of gold adsorption isotherms in which 1) an initial concentration of gold was varied with a concentration of ddFc kept constant at 2 mM; and 2) 5 mM gold was adsorbed with a varying concentration of ddFc adsorbent;

FIG. 32 illustrates a plot of gold adsorption isotherms demonstrating total gold uptake and gold recovery efficiency;

FIG. 33 illustrates a plot of gold uptake and recovery efficiency as concentration of ddFc in the organic phase was increased;

FIG. 34 illustrates a bar graph of gold recovery efficiency with increasing up-concentration ratio (volume ratio of initial gold leach solution (16 mL) to release solution (increasing from 1 to 16 mL);

FIG. 35 illustrates a plot of reversible uptake of gold and silver in a binary solution in which the total metal concentration was kept at 5 mM and the ratio of gold and silver varied, and further illustrates the selectivity factor of gold relative to silver;

FIG. 36 illustrates a plot of a copper adsorption isotherm with ddFc adsorbent in an example of an electrified liquid-liquid extraction system according to the principles of the present disclosure;

FIG. 37 illustrates a plot of reversible uptake of gold and copper in a binary solution in which the total metal concentration was kept at 5 mM and the ratio of gold and copper was varied, and further illustrates the selectivity factor of gold relative to copper;

FIG. 38 illustrates a plot of total gold uptake and recovery efficiency of 5 mM potassium dicyanoaurate with increasing concentration of KCN in the aqueous adsorption solution;

FIG. 39 illustrates a plot of a platinum adsorption isotherm with ddFc adsorbent in an example of an electrified liquid-liquid extraction system according to the principles of the present disclosure, where reversible uptake was fit with a Langmuir isotherm model and irreversible uptake was also plotted, and the platinum species was chloroplatinic acid;

FIG. 40 illustrates a bar graph illustrating a control experiment of the solubility of precious group metal chloro-complexes in various pure organic solvents;

FIG. 41 illustrates a bar graph comparing precious group metal uptake with oxidized ddFc and reduced ddFc, iridium demonstrating spontaneous adsorption;

FIG. 42 illustrates a plot of performance metrics of operation of an example of a continuous flow electrified liquid-liquid extraction system according to the principles of the present disclosure, including molar utilization and gold removal percentage, as a function of time; and

FIG. 43 illustrates a plot of electrochemical response of the membrane-separated flow cell during operation of an example of a continuous flow electrified liquid-liquid extraction system according to the principles of the present disclosure, the flow cell first operating at constant current; then as approaching main operating potential, operating at constant potential; and during cell cooldown, set to open circuit potential.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The uses of the terms “a” and “an” and “the” and similar referents in the context of describing the present disclosure (especially in the context of the following claims) are to be construed to cover both the singular and the plural, unless otherwise indicated herein or clearly contradicted by context. The use of the term “plurality of” is defined by the Applicant in the broadest sense, superseding any other implied definitions or limitations hereinbefore or hereinafter unless expressly asserted by Applicant to the contrary, to mean a quantity of more than one. All methods described herein may be performed in any suitable order unless otherwise indicated herein by context.

As will be understood by one skilled in the art, for any and all purposes, all ranges recited herein also encompass any and all possible sub-ranges and combinations of sub-ranges thereof, as well as the individual values making up the range, particularly integer values. It is therefore understood that each unit between two particular units is also disclosed. For example, if “10 to 15” is disclosed, then 11, 12, 13, and 14 are also disclosed, individually, and as part of a range. A recited range (for example, weight percentages or carbon groups) includes each specific value, integer, decimal, or identity within the range. Any listed range may be easily recognized as sufficiently describing and enabling the same range being broken down into at least equal halves, thirds, quarters, fifths, or tenths. As will also be understood by one skilled in the art, all language such as “up to,” “at least,” “greater than,” “less than,” “more than,” “or more,” and the like, include the number recited and such terms refer to ranges that may be subsequently broken down into sub-ranges. In the same manner, all ratios recited herein also include all sub-ratios falling within the broader ratio. Accordingly, specific values recited for radicals, substituents, and ranges are for illustration only; the specific values do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention compasses not only the main group, but also the main group absent one or more of the group members. The invention therefore envisages the explicit exclusion of any one or more of members of a recited group. Accordingly, provisos may apply to any of the disclosed categories or examples whereby any one or more of the recited elements, species, or examples may be excluded from such categories or examples, for example, for use in an explicit negative limitation.

As used herein, the terms “comprise(s),” “include(s),” “having,” “has,” “may,” “contain(s),” and variants thereof, are intended to be open-ended transitional phrases, terms, or words that do not preclude the possibility of additional acts or structures. The present description also contemplates other examples “comprising,” “consisting of,” and “consisting essentially of,” the examples or elements presented herein, whether explicitly set forth or not.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art.

As used herein, the term “about,” when used in the context of a numerical value or range set forth means a variation of ±15%, or less, of the numerical value. For example, a value differing by ±15%, ±14%, ±10%, or ±5%, among others, would satisfy the definition of “about,” unless more narrowly defined in particular instances.

The term “alkyl,” by itself or as part of another substituent, refers, unless otherwise stated, to a saturated straight, branched, or cyclic chain aliphatic hydrocarbon (“cycloalkyl”) monovalent radical having the number of carbon atoms designated (in other words, “C₁-C₃₀” means one to twenty carbons, and includes C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, and C₂₉). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl. In a particular example, the term “C₁-C₃₀” may not include C₁, and/or may not include C₂, and/or may not include C₃, and/or may not include C₄, and/or may not include C₅, and/or may not include C₆, and/or may not include C₇, and/or may not include C₈, and/or may not include C₉, and/or may not include C₁₀, and/or may not include C₁₁, and/or may not include C₁₂, and/or may not include C₁₃, and/or may not include C₁₄, and/or may not include C₁₅, and/or may not include C₁₆, and/or may not include C₁₇, and/or may not include C₁₈, and/or may not include C₁₉, and/or may not include C₂₀, and/or may not include C₂₁, and/or may not include C₂₂, and/or may not include C₂₃, and/or may not include C₂₄, and/or may not include C₂₅, and/or may not include C₂₆, and/or may not include C₂₇, and/or may not include C₂₈, and/or may not include C₂₉, and/or may not include C₃₀.

The term “halogen,” refers to an element of main group (or column) VIIA of the periodic table, which includes fluorine, chlorine, bromine, iodine, and astatine.

As used herein, the term “reduction-oxidation,” and the portmanteau thereof, “redox,” refer to a type of chemical reaction in which the oxidation states of atoms within reagents change. “Oxidation” refers to the loss of electrons or an increase in the oxidation state of a reagent or atoms thereof. “Reduction” refers to the gain of electrons or a decrease in the oxidation state of a reagent or atoms thereof. Examples of redox reactions may include “electron-transfer” redox reactions in which electrons flow from the reducing agent to the oxidizing agent. The terms “redox-active,” “redox activity,” and “redox potential” refer to a measure of the tendency of a chemical species to acquire electrons from, or lose electrons to, an electrode and thereby reduced or oxidized, respectively.

In describing elements of the present disclosure, the terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the term “electronic waste” refers to any unwanted electronic device, or part or component thereof. Examples of electronic waste may include discarded: cathode ray tube televisions; lithium crystal display (“LCD”), organic light-emitting diode (“OLED”), or plasma televisions; LCD monitors, smart displays, and tablets; laptop computers with LCD monitors; OLED desktop monitors, laptops, and tablets; computers; printers; video-cassette recorders; portable DVD players with video screens; cellular phones; radios; solar panels; or any part or component thereof.

Herein is described an electrified liquid-liquid extraction system that achieves selective gold uptake and up-concentration in a fully continuous manner using gold leach solutions derived from electronic waste or heap leaching with only electrical input. Alternatively, or additionally, an advantage of the extraction systems of the present disclosure may be spontaneous uptake of critical platinum group metals (“PGMs”), thereby leveraging oxidized PGM complexes for simultaneous oxidation and binding to an electrosorbent. Alternatively, or additionally, an advantage of the extraction systems of the present disclosure may be cost reductions in gold recovery, making feasible the economic recovery of previously unrecoverable ultra-low-grade gold.

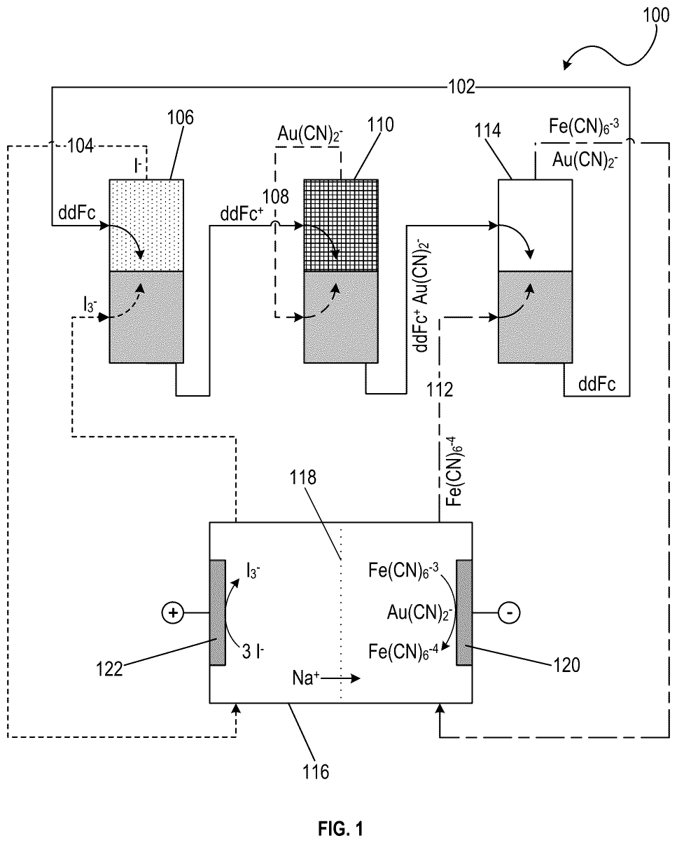

FIG. 1 illustrates a schematic of an example of an electrified liquid-liquid extraction system 100. System 100 includes an organic adsorbent loop 102, through which flows a redox-active ferrocene-based adsorbent, such as 1,1′-didodecylferrocene (ddFc), dissolved in an organic solvent. Organic adsorbent loop 102 includes three consecutive solvent extraction columns in a direction of flow of the ferrocene-based adsorbent solution: oxidation column 106, leach column 110, and reduction column 114. Aqueous oxidant loop 104 also includes oxidation column 106. The ferrocene-based adsorbent in organic adsorbent loop 102 is activated via oxidation in oxidation column 106 via an aqueous oxidizing agent solution flowing through aqueous oxidant loop 104. In the example of system 100, the ferrocene-based adsorbent ddFc is oxidized to oxidized ferrocene-based adsorbent ddFc⁺ by contact of the ferrocene-based adsorbent solution with the aqueous oxidizing agent solution in oxidation column 106. The oxidized ferrocene-based adsorbent, for example ddFc⁺, continues flowing through organic adsorbent loop 102. In leach column 110, the oxidized ferrocene-based adsorbent contacts an aqueous gold-containing leach stream, which flows through leach stream loop 108. Leach stream loop 108 also includes leach column 100. When the oxidized ferrocene-based adsorbent contacts the aqueous gold-containing leach stream, a gold species such as anionic dicyanoaurate ([Au(CN)₂]⁻) may favorably bind to the oxidized ferrocene-based adsorbent, thereby selectively transferring a gold complex from the aqueous gold-containing leach stream to the organic solution in organic adsorbent loop 102. In the present example, the binding of the oxidized ferrocene-based adsorbent, ddFc⁺, and the gold species, [Au(CN)₂]⁻, result in the formation of bound gold species ddFc⁺[Au(CN)₂]⁻. A rendering of ddFc⁺[Au(CN)₂]⁻ is illustrated in FIG. 3. The bound gold species continues flowing through organic adsorbent loop 102. In reduction column 114, the bound gold species contacts an aqueous reducing agent solution flowing through aqueous reductant loop 112 and reversibly releases the gold species, such as [Au(CN)₂]⁻, into the aqueous reducing agent solution and concentrates the gold species in the aqueous reducing agent solution. The gold species is liberated to the aqueous reducing agent solution by reduction of the oxidized ferrocene-based adsorbent back to the ferrocene-based adsorbent with an aqueous reducing agent. Pure metallic gold may be efficiently recovered from aqueous reductant loop 112 via electrodeposition. The aqueous reductant loop 112 also includes reduction column 114. The ferrocene-based adsorbent may be cycled back to oxidation column 106 and reused. Further, the oxidizing agent in the aqueous oxidizing agent solution flowing through aqueous oxidant loop 104 and the reducing agent in the aqueous reducing agent solution flowing through aqueous reductant loop 112 may be simultaneously regenerated in in flow cell 116 partitioned by ion exchange membrane 108. In flow cell 116, the oxidized reducing agent is reduced at anode 120 to regenerate the reducing agent in the aqueous reductant loop 112, and the reduced oxidizing agent is oxidized at cathode 122 to regenerate the oxidizing agent in the aqueous oxidant loop 104. System 100 thereby may achieve selective recovery and purification of gold continuously while only consuming minimal electrical input. Scheme 1 below summarizes the redox chemical reactions and extraction of anionic gold species that may occur in system 100.

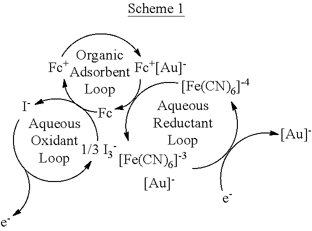

In an example, the ferrocene-based adsorbent is a substituted ferrocene (Fc) species that is a compound of formula (I):

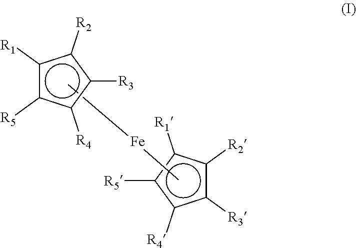

wherein each of R₁, R₂, R₃, R₄, R₅, R₁′, R₂′, R₃′, R₄′, and R₅′ is independently hydrogen or (C₁-C₃₀)alkyl; and at least one of R₁, R₂, R₃, R₄, R₅, R₁′, R₂′, R₃′, R₄′, and R₅′ is (C₁-C₃₀)alkyl. Examples of compounds of formula (I) may include:

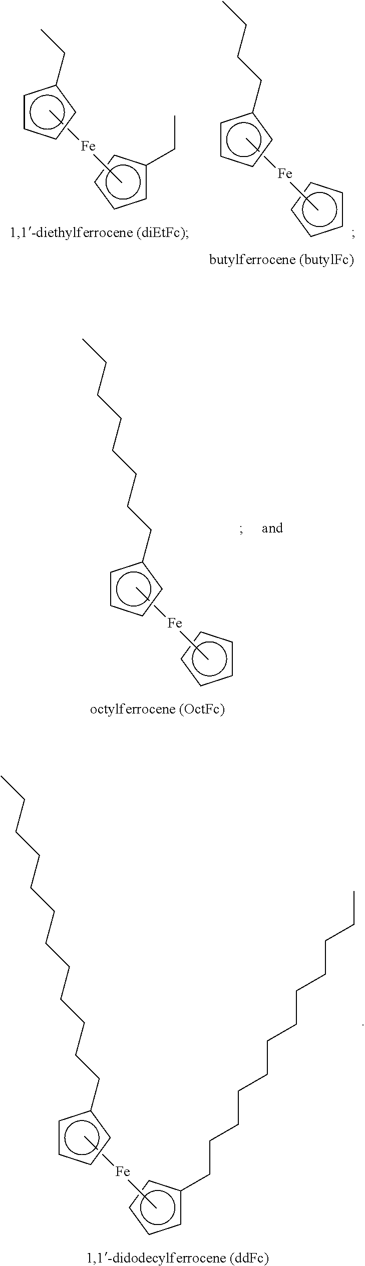

In an example, a “molar utilization” of an example of an electrified liquid-liquid extraction system of the present disclosure may refer to the molar ratio of target ions extracted to compound of formula (I). In certain examples, the molar utilization may be over 50%, or over 52%, or over 54%, or over 56%, or over 58%, or over 60%, or over 62%, or over 64%, or over 66%, or over 68%, or over 70%, or over 72%, or over 74%, or over 76%, or over 78%, or over 80%, or over 82%, or over 84%, or over 86%, or over 88%, or over 90%, or over 92%, or over 94%, or over 96%, or over 98%, or over 100%.

In an example, a leach stream or leach solution may include a target anionic species at a concentration of from 1 part per million (“ppm”) to 100,000 ppm. In certain examples, the leach stream or leach solution may include competing ions in an excess of the target anionic species that is up to a 1000-fold excess.

Examples of target species may include anionic gold species (such as [Au(CN)₂]⁻), anionic platinum species (such as [PtCl₆]²⁻), anionic iridium species (such as [IrCl₆]²⁻), palladium (such as [PdCl₄]²⁻), silver (such as [Ag(CN)₂]⁻), and rhodium (such as [RhCl₆]³⁻).

Competing ions may be metallic or non-metallic, and cationic or anionic. Examples of competing ions may include silver, copper, nickel, iron, sodium, potassium, aluminum, and tin.

The organic solvent in which the compound of formula (I) is dissolved may be any organic solvent that is immiscible with water. Two substances are immiscible if the mixture of the two substances in certain proportions does not form a solution. Examples of organic solvents that are immiscible with water may include dichloromethane, dibromomethane, chloroform, hexanes, xylene, ethyl ether, ethyl acetate, butyl acetate, kerosene, butanol, propanol, and hexanol. In certain examples, the organic solvent may include a halogen. In certain examples, the organic solvent may be dibromomethane, dichloromethane, or a combination thereof.

Examples of oxidizing agents may include NOBF₄, Na₂CrO₄, Na₃VO₄, FeCl₃, NaI₃, and any combination thereof.

Examples of reducing agents may include Na₂S₂O₅, NaS₂O₃, ascorbic acid, Na₄Fe(CN)₆, and any combination thereof.

In an example, a molar ratio of NOBF₄ to an alkyl-substituted ferrocene compound may be about 1:1, less than 1:1, or greater than 1:1. In certain examples, the molar ratio of NOBF₄ to the alkyl-substituted ferrocene compound, or of the alkyl-substituted ferrocene compound to NOBF₄, may be from about 100:1 to about 1:1, including, for example, from about 95:1, or from about 90:1, or from about 85:1, or from about 80:1, or from about 75:1, or from about 70:1, or from about 65:1, or from about 60:1, or from about 55:1, or from about 50:1, or from about 45:1, or from about 40:1, or from about 35:1, or from about 30:1, or from about 25:1, or from about 20:1, or from about 15:1, or from about 10:1, or from about 9:1, or from about 8:1, or from about 7:1, or from about 6:1, or from about 5:1, or from about 4:1, or from about 3:1, or from about 2:1; or to about 95:1, or to about 90:1, or to about 85:1, or to about 80:1, or to about 75:1, or to about 70:1, or to about 65:1, or to about 60:1, or to about 55:1, or to about 50:1, or to about 45:1, or to about 40:1, or to about 35:1, or to about 30:1, or to about 25:1, or to about 20:1, or to about 15:1, or to about 10:1, or to about 9:1, or to about 8:1, or to about 7:1, or to about 6:1, or to about 5:1, or to about 4:1, or to about 3:1, or to about 2:1; or a range formed from any two of the foregoing molar ratios, including any subranges therebetween.

In an example, a pH of an aqueous oxidant solution is about 1, or about 1.5, or about 2, or about 2.5, or about 3, or about 3.5, or about 4, or about 4.5, or about 5, or about 5.5, or about 6, or about 6.5, or a range formed from any two of the foregoing pH values, including any subranges therebetween.

In example, a molar ratio of NaI₃ to an alkyl-substituted ferrocene compound may be about 1:1, less than 1:1, or greater than 1:1. In certain examples, the molar ratio of NaI₃ to the alkyl-substituted ferrocene compound, or of the alkyl-substituted ferrocene compound to NaI₃, may be from about 100:1 to about 1:1, including, for example, from about 95:1, or from about 90:1, or from about 85:1, or from about 80:1, or from about 75:1, or from about 70:1, or from about 65:1, or from about 60:1, or from about 55:1, or from about 50:1, or from about 45:1, or from about 40:1, or from about 35:1, or from about 30:1, or from about 25:1, or from about 20:1, or from about 15:1, or from about 10:1, or from about 9.75:1, or from about 9.50:1, or from about 9:25:1, or from about 9:1, or from about 8.75:1, or from about 8.50:1, or from about 8.25:1, or from about 8:1, or from about 7.75:1, or from about 7.50:1, or from about 7.25:1, or from about 7:1, or from about 6.75:1, or from about 6.50:1, or from about 6.25:1, or from about 6:1, or from about 5.75:1, or from about 5.50:1, or from about 5.25:1, or from about 5:1, or from about 4.75:1, or from about 4.50:1, or from about 4.25:1, or from about 4:1, or from about 3.75:1, or from about 3.50:1, or form about 3.25:1, or from about 3:1, or from about 2.75:1, or from about 2.50:1, or from about 2.25:1, or from about 2:1, or from about 1.75:1, or from about 1.50:1, or from about 1.25:1; or to about 95:1, or to about 90:1, or to about 85:1, or to about 80:1, or to about 75:1, or to about 70:1, or to about 65:1, or to about 60:1, or to about 55:1, or to about 50:1, or to about 45:1, or to about 40:1, or to about 35:1, or to about 30:1, or to about 25:1, or to about 20:1, or to about 15:1, or to about 10:1, or to about 9.75:1, or to about 9.50:1, or to about 9.25:1, or to about 9:1, or to about 8.75:1, or to about 8.50:1, or to about 8.25:1, or to about 8:1, or to about 7.75:1, or to about 7.50:1, or to about 7.25:1, or to about 7:1, or to about 6.75:1, or to about 6.50:1, or to about 6.25:1, or to about 6:1, or to about 5.75:1, or to about 5.50:1, or to about 5.25:1, or to about 5:1, or to about 4.75:1, or to about 4.50:1, or to about 4.25:1, or to about 4:1, or to about 3.75:1, or to about 3.50:1, or to about 3.25:1, or to about 3:1, or to about 2.75:1, or to about 2.50:1, or to about 2.25:1, or to about 2:1, or to about 1.75:1, or to about 1.50:1, or to about 1.25:1; or a range formed from any two of the foregoing molar ratios, including any subranges therebetween.

In an example, a molar ratio of Fe(CN)₆⁴⁻ to an alkyl-substituted ferrocene compound may be about 1:1, less than 1:1, or greater than 1:1. In certain examples, the molar ratio of NOBF₄ to the alkyl-substituted ferrocene compound, or of the alkyl-substituted ferrocene compound to NOBF₄, may be from about 100:1 to about 1:1, including, for example, from about 95:1, or from about 90:1, or from about 85:1, or from about 80:1, or from about 75:1, or from about 70:1, or from about 65:1, or from about 60:1, or from about 55:1, or from about 50:1, or from about 45:1, or from about 40:1, or from about 35:1, or from about 30:1, or from about 25:1, or from about 20:1, or from about 15:1, or from about 10:1, or from about 9:1, or from about 8:1, or from about 7:1, or from about 6:1, or from about 5:1, or from about 4:1, or from about 3:1, or from about 2:1; or to about 95:1, or to about 90:1, or to about 85:1, or to about 80:1, or to about 75:1, or to about 70:1, or to about 65:1, or to about 60:1, or to about 55:1, or to about 50:1, or to about 45:1, or to about 40:1, or to about 35:1, or to about 30:1, or to about 25:1, or to about 20:1, or to about 15:1, or to about 10:1, or to about 9:1, or to about 8:1, or to about 7:1, or to about 6:1, or to about 5:1, or to about 4:1, or to about 3:1, or to about 2:1; or a range formed from any two of the foregoing molar ratios, including any subranges therebetween.

In an example, a gold concentration in a leach solution may be from about 0.0001 mM to about 100 mM, including, for example, from about 0.0005 mM, or from about 0.001 mM, or from about 0.005 mM, or from about 0.01 mM, or from about 0.05 mM, or from about 0.1 mM, or from about 0.2 mM, or from about 0.2 mM, or from about 0.3 mM, or from about 0.4 mM, or from about 0.5 mM, or from about 0.6 mM, or from about 0.7 mM, or from about 0.8 mM, or from about 0.9 mM, or from about 1.0 mM, or from about 2.0 mM, or from about 3.0 mM, or from about 4.0 mM, or from about 5.0 mM, or from about 6.0 mM, or from about 7.0 mM, or from about 8.0 mM, or from about 9.0 mM, or from about 10.0 mM, or from about 20.0 mM, or from about 30.0 mM, or from about 40.0 mM, or from about 50.0 mM, or from about 60.0 mM, or from about 70.0 mM, or from about 80.0 mM, or from about 90.0 mM; or to about 0.0005 mM, or to about 0.001 mM, or to about 0.005 mM, or to about 0.01 mM, or to about 0.05 mM, or to about 0.1 mM, or to about 0.2 mM, or to about 0.3 mM, or to about 0.4 mM, or to about 0.5 mM, or to about 0.6 mM, or to about 0.7 mM, or to about 0.8 mM, or to about 0.9 mM, or to about 1.0 mM, or to about 2.0 mM, or to about 3.0 mM, or to about 4.0 mM, or to about 5.0 mM, or to about 6.0 mM, or to about 7.0 mM, or to about 8.0 mM, or to about 9.0 mM, or to about 10.0 mM, or to about 20.0 mM, or to about 30.0 mM, or to about 40.0 mM, or to about 50.0 mM, or to about 60.0 mM, or to about 70.0 mM, or to about 80.0 mM, or to about 90 mM; or a range formed from any two of the foregoing molarities, including any subranges therebetween.

In an example, a volume ratio of a leach solution to an aqueous reductant solution, or of the aqueous reductant solution to the leach solution, may be from about 1:1 to about 16:1, including, for example, from about 1.5:1, or from about 2:1, or from about 2.5:1, or from about 3:1, or from about 3.5:1, or from about 4:1, or from about 4.5:1, or from about 5:1, or from about 5.5:1, or from about 6:1, or from about 6.5:1, or from about 7:1, or from about 7.5:1, or from about 8:1, or from about 8.5:1, or from about 9:1, or from about 9.5:1, or from about 10:1, or from about 10.5:1, or from about 11:1, or from about 11.5:1, or from about 12:1, or from about 12.5:1, or from about 13:1, or from about 13.5:1, or from about 14:1, or from about 14.5:1, or form about 15:1, or from about 15.5:1; or to about 1.5:1, or to about 2:1, or to about 2.5:1, or to about 3:1, or to about 3.5:1, or to about 4:1, or to about 4.5:1, or to about 5:1, or to about 5.5:1, or to about 6:1, or to about 6.5:1, or to about 7:1, or to about 7.5:1, or to about 8:1, or to about 8.5:1, or to about 9:1, or to about 9.5:1, or to about 10:1, or to about 10.5:1, or to about 11:1, or to about 11.5:1, or to about 12:1, or to about 12.5:1, or to about 13:1, or to about 13.5:1, or to about 14:1, or to about 14.5:1, or to about 15:1, or to about 15.5:1; or a range formed from any two of the foregoing volume ratios, including any subranges therebetween.

In an example, a method of recovering a metal from a leach solution may include: cycling a solution of an alkyl-substituted ferrocene compound in an organic solvent sequentially through an oxidation solvent extraction column, a leach solvent extraction column, and a reduction solvent extraction column in an organic adsorbent loop; oxidizing the alkyl-substituted ferrocene compound in the oxidation solvent extraction column to provide an oxidized alkyl-substituted ferrocene compound; adsorbing an anionic species of the metal from the leach solution to the oxidized alkyl-substituted ferrocene compound in the leach solvent extraction column to provide a complex of the anionic species and the oxidized alkyl-substituted ferrocene compound; and reducing the oxidized alkyl-substituted ferrocene compound to provide the alkyl-substituted ferrocene compound in the reduction solvent extraction column, the anionic species transferred to an aqueous reductant solution in the reduction solvent extraction column. In certain examples the cycling may be performed continuously. In certain examples, the oxidizing may include cycling an aqueous oxidant solution including an oxidizing agent through an aqueous oxidant loop, the aqueous oxidant loop including the oxidation solvent extraction column. In certain examples, the reducing may include cycling an aqueous reductant solution including a reducing agent through an aqueous reductant loop, the aqueous reductant loop including the reduction solvent extraction column. In certain examples, the adsorbing may include cycling the leach solution through a leach stream loop including the leach solvent extraction column. In certain examples, the method may further include regenerating the oxidizing agent at an anode of a flow cell, the aqueous oxidant loop including the anode downstream of the oxidation solvent extraction column. In certain examples, the method may further include regenerating the reducing agent at a cathode of a flow cell, the aqueous reductant loop including the cathode downstream of the reduction solvent extraction column. In certain examples, the method may further include preparing the leach solution from electronic waste. In certain examples, the leach solution may be prepared by heap leaching or dump leaching.

In an example, a gold uptake from the leach solution may be from about 100 milligrams of gold per gram of the alkyl-substituted ferrocene compound (“mg/g”) to about 500 mg/g, including, for example, from about 125 mg/g, or from about 150 mg/g, or from about 175 mg/g, or from about 200 mg/g, or from about 225 mg/g, or from about 250 mg/g, or from about 275 mg/g, or from about 300 mg/g, or from about 325 mg/g, or from about 350 mg/g, or from about 375 mg/g, or from about 400 mg/g, or from about 425 mg/g, or from about 450 mg/g, or from about 475 mg/g; or to about 125 mg/g, or to about 150 mg/g, or to about 175 mg/g, or to about 200 mg/g, or to about 225 mg/g, or to about 250 mg/g, or to about 275 mg/g, or to about 300 mg/g, or to about 325 mg/g, or to about 350 mg/g, or to about 375 mg/g, or to about 400 mg/g, or to about 425 mg/g, or to about 450 mg/g, or to about 475 mg/g; or a range made up from any two of the foregoing mg/g values, including any subranges therebetween.

In an example, a gold recovery efficiency from the leach solution to the aqueous reductant solution may be from about 80% to about 99%, including, for example, from about 80.5%, or from about 81%, or from about 81.5%, or from about 82%, or from about 82.5%, or from about 83%, or from about 83.5%, or from about 84%, or from about 84.5%, or from about 85%, or from about 85.5%, or from about 86%, or from about 86.5%, or from about 87%, or from about 87.5%, or from about 88%, or from about 88.5%, or from about 89%, or from about 89.5%, or from about 90%, or from about 90.5%, or from about 91%, or from about 91.5%, or from about 92%, or from about 92.5%, or from about 93%, or from about 93.5%, or from about 94%, or from about 94.5%, or from about 95%, or from about 95.5%, or from about 96%, or from about 96.5%, or from about 97%, or from about 97.5%, or from about 98%, or from about 98.5%; or to about 80.5%, or to about 81%, or to about 81.5%, or to about 82%, or to about 82.5%, or to about 83%, or to about 83.5%, or to about 84%, or to about 84.5%, or to about 85%, or to about 85.5%, or to about 86%, or to about 86.5%, or to about 87%, or to about 87.5%, or to about 88%, or to about 88.5%, or to about 89%, or to about 89.5%, or to about 90%, or to about 90.5%, or to about 91%, or to about 91.5%, or to about 92%, or to about 92.5%, or to about 93%, or to about 93.5%, or to about 94%, or to about 94.5%, or to about 95%, or to about 95.5%, or to about 96%, or to about 96.5%, or to about 97%, or to about 97.5%, or to about 98%, or to about 98.5%; or a range formed from any two of the foregoing efficiencies, including any subranges therebetween.

In an example, a molar utilization may be from about 80% to about 99%, including, for example, from about 80.5%, or from about 81%, or from about 81.5%, or from about 82%, or from about 82.5%, or from about 83%, or from about 83.5%, or from about 84%, or from about 84.5%, or from about 85%, or from about 85.5%, or from about 86%, or from about 86.5%, or from about 87%, or from about 87.5%, or from about 88%, or from about 88.5%, or from about 89%, or from about 89.5%, or from about 90%, or from about 90.5%, or from about 91%, or from about 91.5%, or from about 92%, or from about 92.5%, or from about 93%, or from about 93.5%, or from about 94%, or from about 94.5%, or from about 95%, or from about 95.5%, or from about 96%, or from about 96.5%, or from about 97%, or from about 97.5%, or from about 98%, or from about 98.5%; or to about 80.5%, or to about 81%, or to about 81.5%, or to about 82%, or to about 82.5%, or to about 83%, or to about 83.5%, or to about 84%, or to about 84.5%, or to about 85%, or to about 85.5%, or to about 86%, or to about 86.5%, or to about 87%, or to about 87.5%, or to about 88%, or to about 88.5%, or to about 89%, or to about 89.5%, or to about 90%, or to about 90.5%, or to about 91%, or to about 91.5%, or to about 92%, or to about 92.5%, or to about 93%, or to about 93.5%, or to about 94%, or to about 94.5%, or to about 95%, or to about 95.5%, or to about 96%, or to about 96.5%, or to about 97%, or to about 97.5%, or to about 98%, or to about 98.5%; or a range formed from any two of the foregoing molar utilizations, including any subranges therebetween.

In an example, a percentage of an anionic species transferred to an aqueous reductant solution may 80% to about 99.9%, including, for example, from about 80.5%, or from about 81%, or from about 81.5%, or from about 82%, or from about 82.5%, or from about 83%, or from about 83.5%, or from about 84%, or from about 84.5%, or from about 85%, or from about 85.5%, or from about 86%, or from about 86.5%, or from about 87%, or from about 87.5%, or from about 88%, or from about 88.5%, or from about 89%, or from about 89.5%, or from about 90%, or from about 90.5%, or from about 91%, or from about 91.5%, or from about 92%, or from about 92.5%, or from about 93%, or from about 93.5%, or from about 94%, or from about 94.5%, or from about 95%, or from about 95.5%, or from about 96%, or from about 96.5%, or from about 97%, or from about 97.5%, or from about 98%, or from about 98.5%, or from about 99%, or from about 99.1%, or from about 99.2%, or from about 99.3%, or from about 99.4%, or from about 99.5%, or from about 99.6%, or from about 99.7%, or from about 99.8; or to about 80.5%, or to about 81%, or to about 81.5%, or to about 82%, or to about 82.5%, or to about 83%, or to about 83.5%, or to about 84%, or to about 84.5%, or to about 85%, or to about 85.5%, or to about 86%, or to about 86.5%, or to about 87%, or to about 87.5%, or to about 88%, or to about 88.5%, or to about 89%, or to about 89.5%, or to about 90%, or to about 90.5%, or to about 91%, or to about 91.5%, or to about 92%, or to about 92.5%, or to about 93%, or to about 93.5%, or to about 94%, or to about 94.5%, or to about 95%, or to about 95.5%, or to about 96%, or to about 96.5%, or to about 97%, or to about 97.5%, or to about 98%, or to about 98.5%, or to about 99%, or to about 99.1%, or to about 99.2%, or to about 99.3%, or to about 99.4%, or to about 99.5%, or to about 99.6%, or to about 99.7%, or to about 99.8%; or a range formed from any two of the foregoing percentages, including any subranges therebetween.

In an example, a transfer of at least 99% of an anionic species to an aqueous reductant solution may be in less than 1 hour, or in less than 55 minutes, or in less than 50 minutes, or in less than 45 minutes, or in less than 40 minutes, or in less than 35 minutes, or in less than 30 minutes, or in less than 25 minutes, or in less than 20 minutes, or in less than 15 minutes, or in less than 10 minutes, or in less than 570 seconds, or in less than 540 seconds, or in less than 510 seconds, or in less than 480 seconds, or in less than 450 seconds, or in less than 420 seconds, or in less than 390 seconds, or in less than 360 seconds, or in less than 330 seconds, or in less than 5 minutes, or in less than 270 seconds, or in less than 240 seconds, or in less than 210 seconds, or in less than 180 seconds, or in less than 150 seconds, or in less than 120 seconds, or in less than 110 seconds, or in less than 100 seconds, or in less than 90 seconds, or in less than 80 seconds, or in less than 70 seconds, or in less than 60 seconds, or in less than 50 seconds, or in less than 40 seconds, or in less than 30 seconds, or in less than 20 seconds, or in less than 10 seconds, or in less than 5 seconds; or a range formed from any two of the above durations, including any subranges therebetween.

The systems and methods described above may be better understood in connection with the following Examples. In addition, the following non-limiting examples are an illustration. The illustrated systems methods are applicable to other examples of electrified liquid-liquid extraction of the present disclosure. The procedures described as general methods describe what is believed will be typically effective to prepare the systems indicated. However, the person skilled in the art will appreciate that it may be necessary to vary the procedures for any given example of the present disclosure, for example, vary the order or steps and/or the chemical reagents used.

### EXAMPLES

### I. Selection of Ferrocene-Based Adsorbents.

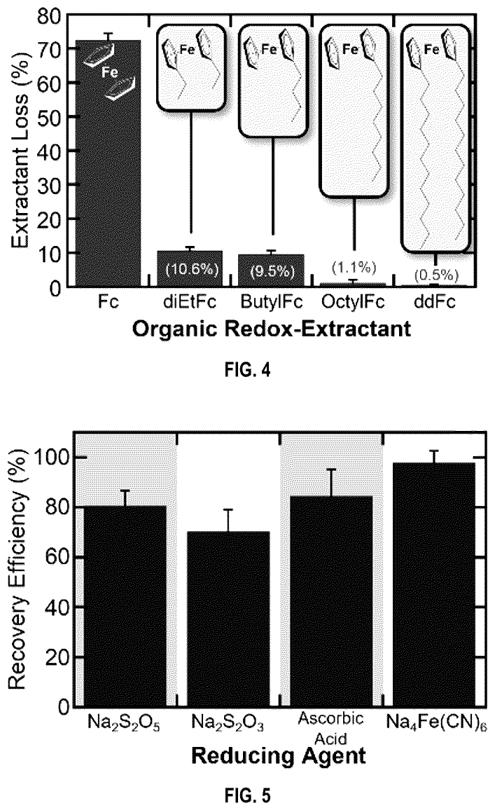

The amount of loss of oxidized ferrocene-based adsorbent from the organic solution to the aqueous reducing agent solution was determined with inductively coupled plasma optical emission spectroscopy (“ICP-OES”) for ferrocene (Fc), 1,1′-diethylferrocene (diEtFc), octylferrocene (OctFc), and 1,1′-didodecylferrocene (ddFc), and the results are illustrated in FIG. 4. 1,1′-Didodecylferrocene (ddFc) had the least amount of loss. Without functionalization, 42% of ferrocene was lost to the aqueous phase when oxidized, which may be due to the +1 formal charge on ferrocenium, and as the alkyl substituents increased in length, the ferrocene unit was more effectively sequestered to the organic phase, with only 0.6% of ddFc lost after vigorous sonication of liquid phases.

### II. Solvent Selection.

Various organic solvents were tested for use in the solution in an organic adsorbent loop were tested in an example of an electrified liquid-liquid extraction system. Gold uptake and release batch experiments using ddFc as the compound of formula (I) were performed in halogenated organic solvents chloroform, dichloromethane (“DCM”), and dibromomethane (“DBM”). As illustrated in FIG. 23, the experiments in halogenated solvents resulted in high (for example, >250 mg_{Au}/g_{ddFc}) gold uptake from aqueous leach, with >93% recovery efficiency, which refers to the amount of adsorbed gold being successfully released. The experiments in the halogenated solvents demonstrated results that were significantly superior to the results illustrated in FIG. 23 in hydrocarbon solvents hexane, cyclohexane, and xylene. Dibromomethane (DBM) demonstrated the highest uptake (350 mg/g) and recovery efficiency (96%), with DCM demonstrating the second-highest (301 mg/g uptake and 94% recovery).

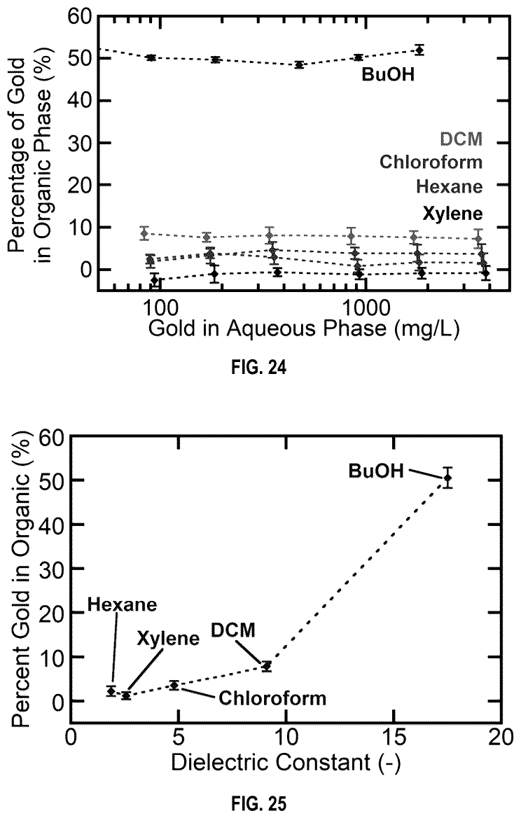

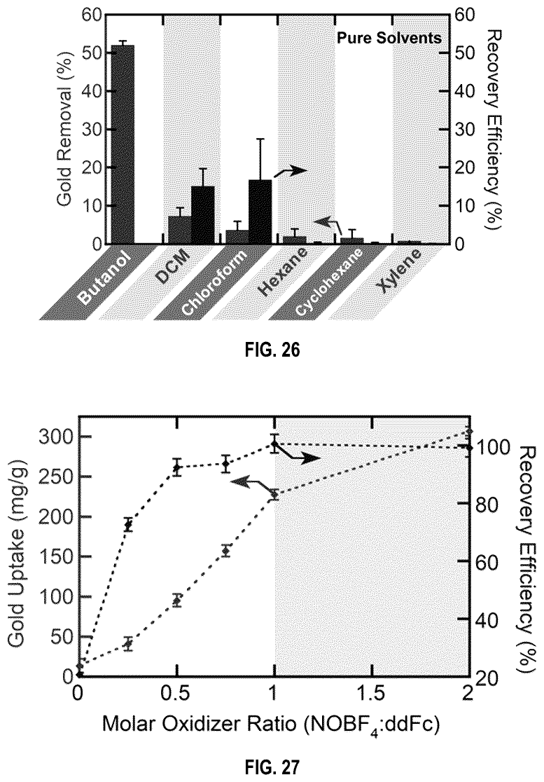

To better understand the effect of solvent in gold extraction, aqueous gold solution was exposed to pure organic solvents including butanol (“BuOH”), DCM, chloroform, hexane, and xylene, and the percentage of gold lost from the aqueous solution was calculated using ICP-OES over a range of gold concentrations including 0.5, 1, 2, 5, 10, and 20 mM KAu(CN)₂. From the results illustrated in FIG. 24, the fraction of gold soluble in the organic phase was found to be independent of the initial aqueous gold concentration. Notably, the fraction of gold soluble in the organic phase correlated directly with the dielectric constants of the pure solvents, as illustrated in FIG. 25. As illustrated in FIG. 26, butanol had the highest gold solubility of all tested solvents, with 50.5% of gold transferring to the organic phase. When the gold-laden butanol organic phase was then exposed to pure water, only 0.6% of gold was transferred, indicating that the mechanism of adsorption with pure butanol was an irreversible process. The mechanism of gold adsorption was found to be irreversible for all pure organic solvents.

### III. Oxidizing Agent Selection.

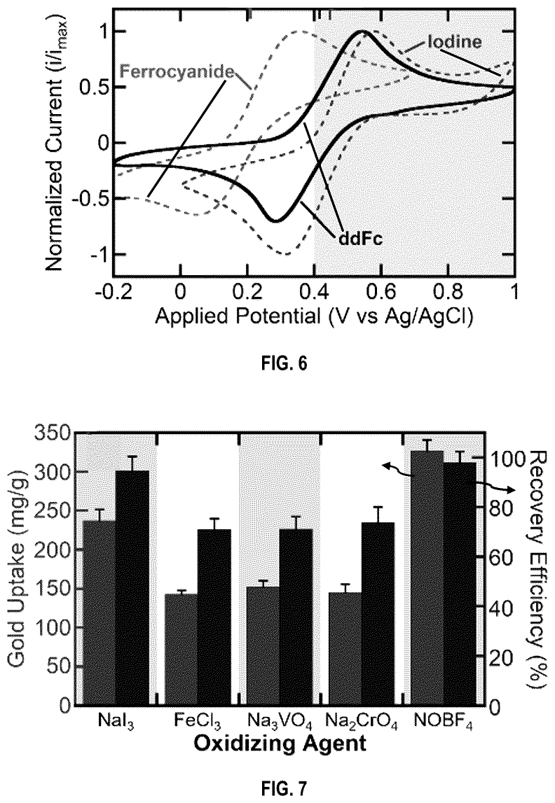

To enable the selective extraction of gold, the organic compound of formula (I) must be oxidized with an oxidizing agent suitable for oxidizing the iron center of the compound of formula (I) from Fe(II) to Fe(III). As illustrated in FIG. 6, a cyclic voltammogram of ddFc in DCM, with 100 mM tetrabutylammonium hexafluorophosphate as supporting electrolyte, yielded a reversible voltammogram with a half-cell potential of 0.41 V vs. Ag/AgCl, which remained stable for all 100 tested cycles. The standard oxidizing agent for generation of oxidized ferrocene, nitrosonium tetrafluoroborate (NOBF₄), was confirmed to oxidize ddFc(II) to ddFc(III)⁺ according to UV-Vis spectroscopic analysis, as illustrated in FIG. 13. An adsorption peak for ddFc(II) was observed at 420 nm and a peak for ddFc(III)⁺ was observed at 670 nm, which correspond to the results for ferrocene and oxidized ferrocene according to literature. Extraction of 5 mM KAu(CN)₂ with 2 mM ddFc in DCM was carried out with a range of NOBF₄ concentrations (0-4 mM), and gold uptake increased from 8 mg/g (0 mM oxidizing agent) to 300 mg/g (4 mM NOBF₄) as the ratio of NOBF₄ increased, as illustrated in FIG. 27. At a 1:1 molar ratio of NOBF₄:ddFc, a molar percent of gold to ddFc in the organic phase after adsorption (or “molar utilization”) was achieved.

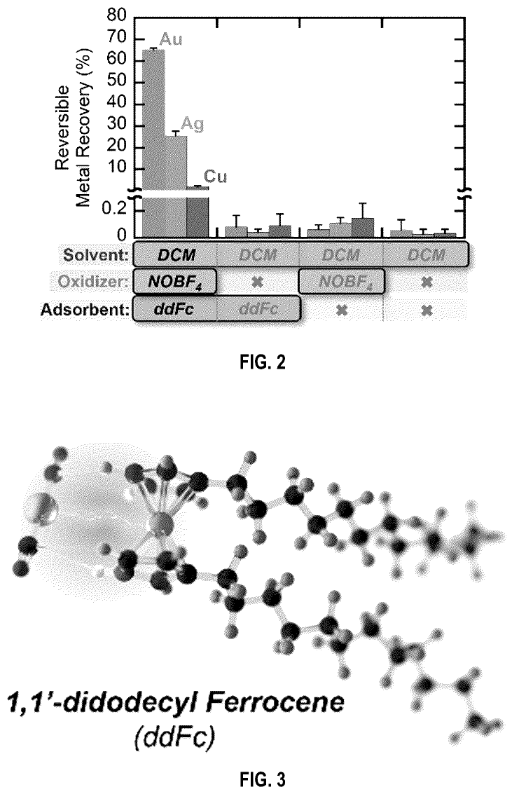

A series of control gold adsorption experiments were conducted to elucidate the mechanism of gold extraction from the aqueous phase to the organic DCM phase, and the results were illustrated in FIG. 2. First, extraction of KAu(CN)₂ was attempted with pure DCM solvent, resulting in only 0.11% gold extraction. For a second control experiment, gold was extracted with only 2 mM NOBF₄ in DCM (no ddFc), again resulting in negligible gold extraction (0.13%). Gold extraction with only 2 mM ddFc in DCM (no oxidizing agent) resulted in 0.13% gold extraction. Finally, extraction was carried out with both ddFc and NOBF₄, resulting in a distinct color change in the organic phase from yellow to blue and 65% of gold extracted within 10 seconds of shaking. Therefore, it was concluded that anionic gold extraction was only possible with the combination of ddFc and NOBF₄ oxidizing agent. An absorbance peak at 670 nm was observed in the UV-Vis spectra of after-gold adsorption with ddFc and NOBF₄ illustrated in FIG. 13, matching the oxidized spectrum of oxidized ddFc(III)⁺. Therefore, the active gold-adsorbing species was found to be oxidized ddFc⁺ due to favorable charge transfer binding. The ddFc advantageously acted as an electrochemically switchable phase transfer catalyst for the dicyanoaurate anion.

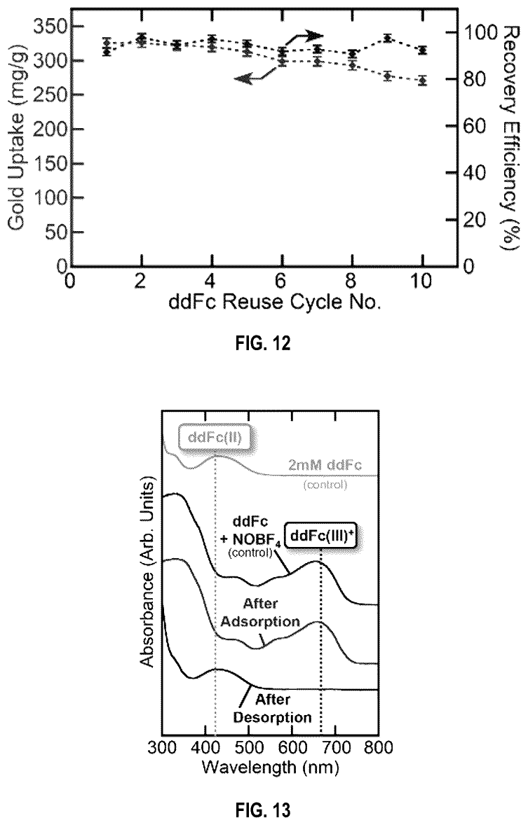

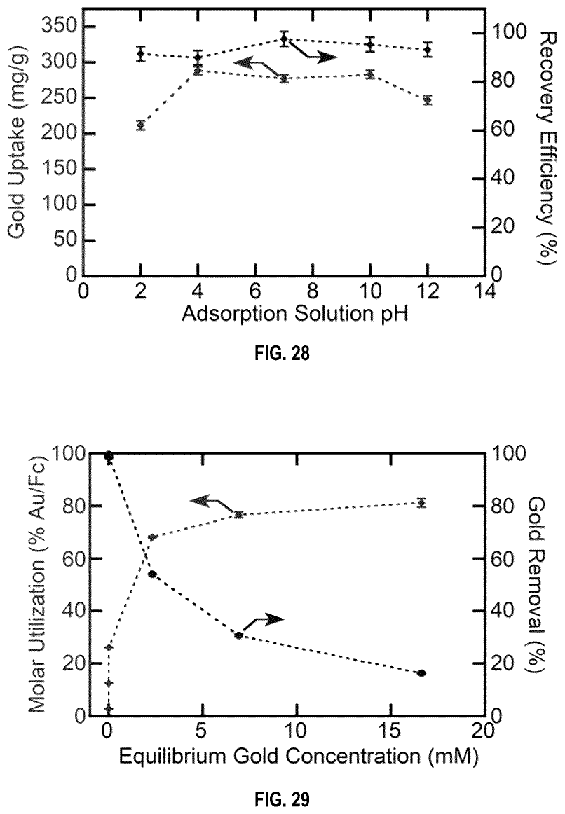

Expanding further on the study of oxidizing agents, Na₂CrO₄, Na₃VO₄, FeCl₃, and NaI₃ were used as representative species of Cr, V, Fe, and I oxidizing agents, respectively. 2 mM ddFc in DCM was oxidized with 10 mM of an aqueous solution of each of Na₂CrO₄, Na₃VO₄, FeCl₃, and NaI₃, and the liquid-liquid mixture was shaken for 10 seconds, then allowed to phase separate for 1 minute. For Na₂CrO₄, Na₃VO₄, and FeCl₃ oxidizing agent, 10 mM of perchloric acid was present to ensure the redox-active species was present. For iodine, the triiodide species was generated from stoichiometric iodate with excess iodide at a neutral pH. Oxidation of ddFc was visually confirmed by a rapid color change of the DCM layer from yellow to blue. The oxidized ddFc⁺ organic phase was then transferred to a new vial, containing 5 mM of aqueous KAu(CN)₂, shaken, and allowed to separate again. Gold uptake was calculated from the aqueous gold concentration before and after adsorption with ICP-OES, as illustrated in FIG. 12, which demonstrated that gold was adsorbed by oxidized ddFc⁺ to a varying degree. The gold uptake when Na₂CrO₄, Na₃VO₄, and FeCl₃ were used as oxidizing agent was 56% lower (150 mg/g uptake) than direct organic phase oxidation with NOBF₄, despite adequate electrochemical driving force (E⁰=0.57 V vs. Ag/AgCl for FeCl₃, 0.8 V for Na₃VO₄, and 1.16 V for Na₂CrO₄). Each of Na₂CrO₄, Na₃VO₄, and FeCl₃ oxidizing agent solutions had a pH of 2. Therefore, gold uptake with ddFc and control oxidizing agent NOBF₄ was measured over a range of aqueous adsorption solution pH from 2 to 10. As illustrated in FIG. 28, the results demonstrated a loss in gold uptake below a pH of 2, which is correlated to the low uptake performance of acidic aqueous oxidizing agents including active Cr, V, and Fe species despite adequate oxidation overpotential.

### A. Iodine Oxidizing Agent.

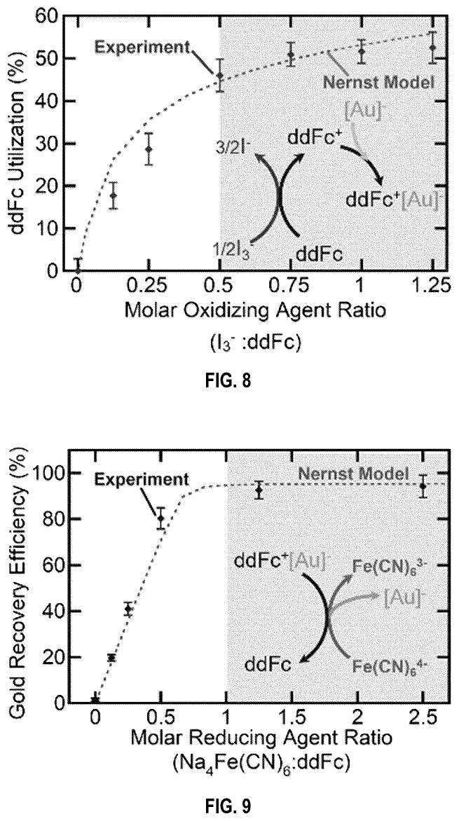

Aqueous triiodide may readily transform to diatomic iodine when exposed to organic solvent. When aqueous triiodide was applied to an example of an electrified liquid-liquid extraction system of the present disclosure, triiodide oxidizing agent achieved a high gold uptake of 237 mg/g, as illustrated in FIG. 7, with a low, economical driving overpotential of 0.05 V (E^{1/2}=0.46 V vs. Ag/AgCl, as illustrated in FIG. 6. When the concentration of triiodide oxidizing agent was varied from 0 mM to 5 mM (1.25 mol I₃⁻ per 1 mol ddFc), an increase in gold uptake was observed with a maximum of 198 mg/g at 5 mM I₃⁻, and experimental data matched the theoretical equilibrium Nernstian response (R²=0.98) of 2-election iodine reduction and 1-electron ddFc oxidation, as illustrated in FIG. 8. Therefore, ddFc oxidation with iodine was rapid, achieving equilibrium within 10 seconds. In the Nernstian model, it was assumed that all oxidized ddFc⁺ would uptake an equimolar amount of anionic gold species, and the assumption was likely accurate, implying that molar utilization represents the percentage of ddFc oxidation for batch gold adsorption results.

### IV. Reducing Agent Selection.

After gold adsorbs to oxidized compound of formula (I) in organic solution, electrochemical release and concentration of organic-bound cyano-gold to an aqueous purification stream was attempted by reduction of the oxidized compound of formula (I) with an aqueous reducing agent. 10 mM of each of several aqueous reducing agents, specifically, Na₂S₂O₅, NaS₂O₃, ascorbic acid, and Na₄Fe(CN)₆, were used to recover gold adsorbed by 2 mM ddFc in DCM (oxidized with 2 mM NOBF₄). For sodium thiosulfate (NaS₂O₃) and sodium metabisulfite (NaS₂O₅), 10 mM of NaOH was added to the aqueous reduction/release solution to ensure facile electron transfer. The resulting percentage of adsorbed gold that was successfully transferred to the reduction/release solution (“gold recovery efficiency”) from various reducing agents was illustrated in FIG. 5, and all reducing agents resulted in a color change in the organic phase from blue of ddFc⁺ back to yellow of ddFc. Sodium thiosulfate demonstrated the lowest recovery efficiency of 70.3%, followed by sodium metabisulfite (80%), and ascorbic acid (81%). Sodium ferrocyanide achieved nearly complete gold recovery at 97.7±1%, and the UV-Vis spectra of the ddFc-containing organic phase after desorption with ferrocyanide contained only one absorption peak at 420 nm, indicating the presence of only reduced ddFc, as illustrated in FIG. 13. Gold was recovered from 2 mM ddFc⁺ in DCM (with equimolar NOBF₄) using aqueous ferrocyanide of varying concentration (0 to 20 mM), and the resulting experimental gold recovery efficiency data was compared to a Nernstian equilibrium model in FIG. 9. The gold recovery efficiency increased from 0% to 96% when the molar ferrocyanide:ddFc ratio was 1:1, and approached 98% with excess ferrocyanide, and the Nernst model captured experimental results well (R²=0.991). Therefore, ferrocyanide rapidly reduced ddFc⁺ to ddFc, causing anionic dicyanoaurate to release from the organic phase and enter the aqueous ferrocyanide solution. The half-cell potential ferri/ferrocyanide redox couple was 0.21 V vs. Ag/AgCl, was illustrated in FIG. 6.

### V. Batch-Scale Gold Recovery Testing.

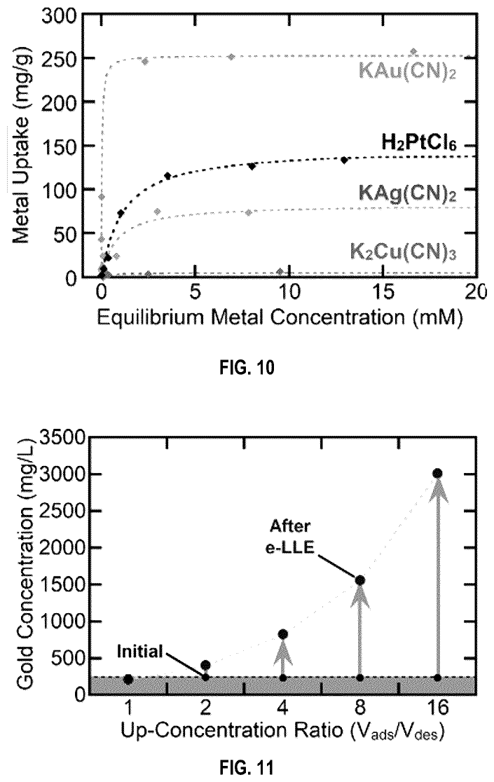

A gold adsorption isotherm was constructed using 2 mL of 2 mM ddFc in DCM oxidized with equimolar NOBF₄, and 1 mL of an aqueous KAu(CN)₂ solution of a concentration between 0.1 mM and 20 mM. Gold adsorption was carried out after shaking dichloromethane and aqueous solutions in a sealed vial for 10 seconds, and the gold-laden organic phase was transferred to a new vial containing 1 mL of aqueous 10 mM Na₄Fe(CN)₆ to reduce ddFc and relinquish the captured gold to the aqueous reduction solution. The same process was carried out for adsorption targets KAg(CN)₂ and K₂Cu(CN)₃, and the resulting reversible uptake isotherms showed favorability to gold, followed by silver, with negligible uptake of copper, as illustrated in FIG. 10.

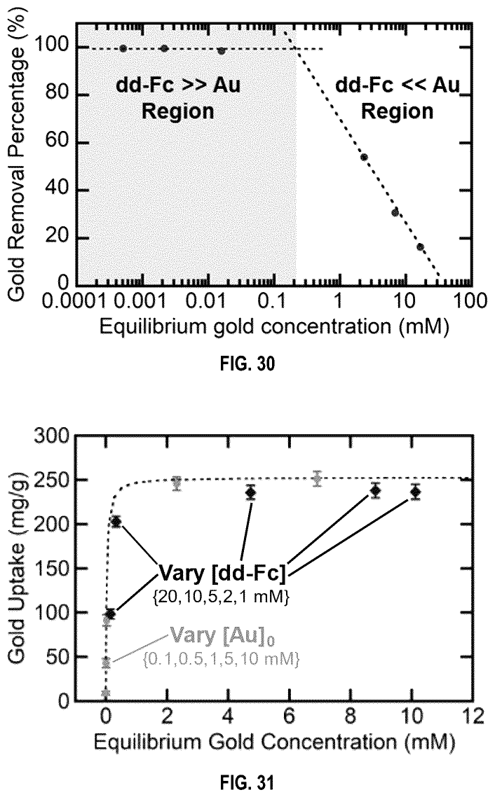

For gold, the Langmuir isotherm model fit the experimental results well (R²=0.992) with Qₘₐₓ of 253 mg_{Au}/g_{ddFc}, and an equilibrium coefficient, K_{eq}=39.4 mM⁻¹, as illustrated in FIG. 10. Gold uptake rapidly approached a maximum beyond a gold concentration of 0.2 mM, indicating that dicyanoaurate-ddFc binding was highly favorable, as illustrated in FIG. 29. Below a gold concentration of 0.2 mM, over 99% of gold was removed in a single adsorption pass, and above 0.2 mM, 81% of ddFc was utilized for the uptake of gold, which demonstrated that ddFc was a high-performance gold adsorbent with impressive atom efficiency, as illustrated in FIG. 30. When the concentration of ddFc in the organic phase was varied between 1 mM and 20 mM with the concentration of aqueous KAu(CN)₂ held constant at 10 mM, the resulting gold adsorption isotherm matched the Langmuir model well, as illustrated in FIG. 31, confirming that Langmuir adsorption fully captures the gold-ddFc adsorption equilibrium regardless of gold and ddFc concentration.

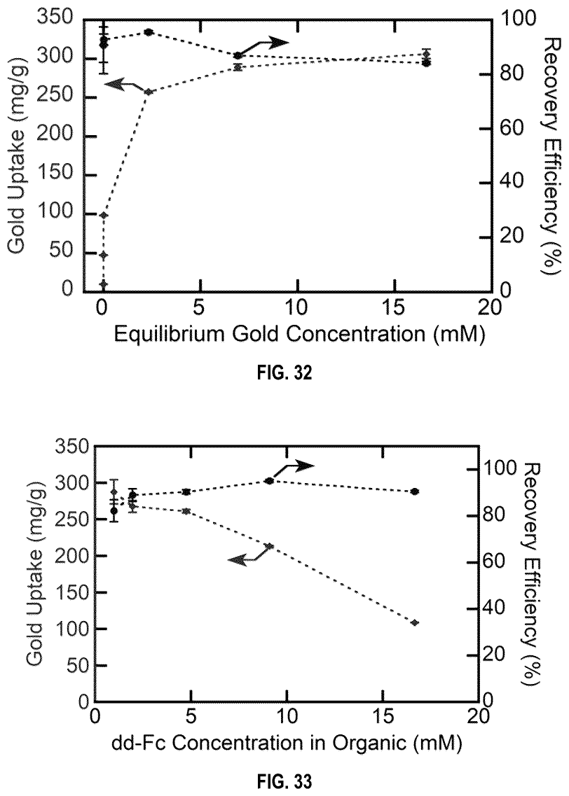

Over a range of gold concentrations from 0.1 to 20 mM, as illustrated in FIG. 32, and ddFc concentrations from 1 mM to 20 mM, as illustrated in FIG. 33, gold capture was highly reversible, with over 90% recovery efficiency. 2 mM ddFc in DCM was reused over 10 adsorption and desorption cycles of 5 mM KAu(CN)₂, and gold uptake remained consistently high (average of 304 mg/g) with a slight loss of utilization from 86% to 72% by the 10^{th} reuse cycle, as illustrated in FIG. 12, which may be accounted for by losses in liquid handling in the batch process. Gold recovery efficiency remained consisting high, at an average of 94%, indicating that ddFc was successfully regenerated each cycle and capable of repeated turnover.

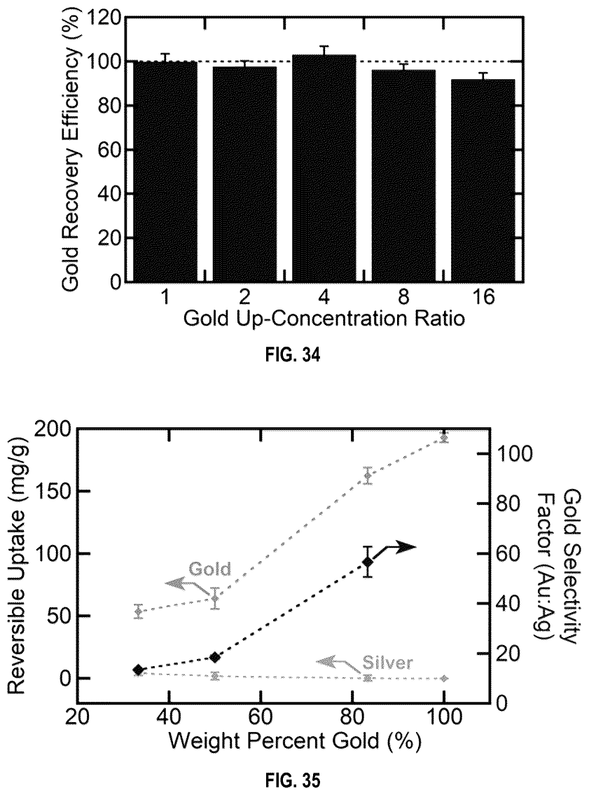

Up-concentration of gold with an example of the electrified liquid-liquid extraction system of a present disclosure, wherein the compound of formula (I) used is ddFc, was investigated by changing the volume ratio of aqueous adsorbing and aqueous desorbing solution from 1:1 to 16:1 for a theoretical gold up-concentration ratio of 16. After adsorbing 1 mM KAu(CN)₂ with 2 mM of oxidized ddFc⁺ in DCM and desorbing the organic-bound gold into aqueous ferrocyanide solution, the gold recovery efficiency was 97±4% for all up-concentration ratios of gold, as illustrated in FIG. 34. Adsorption of 235 mg/L of gold from a 16 mL solution and subsequent desorption to a 1 mL solution yielded a final gold concentration of 3012±7 mg/L, as illustrated in FIG. 11, with a recovery efficiency of 92%, demonstrating that up-concentration was possible with an example of an electrified liquid-liquid extraction system of the present disclosure.

### VI. Multi-Component Performance.

Adsorption isotherms were constructed for KAg(CN)₂ and K₂Cu(CN)₃ over a range of concentrations from 0.1 mM to 20 mM with 2 mM ddFc in DCM oxidized with equimolar NOBF₄, and the reversible uptake isotherms of silver and copper were compared to gold, as illustrated in FIG. 10. Silver uptake with ddFc was highly irreversible, with an average recovery efficiency of 35%, indicating that ddFc adsorption was not the major mechanism of silver removal. Control experiments demonstrated that negligible silver removal occurred in pure DCM, in DCM with ddFc, and in DCM with NOBF₄, and silver removal only occurred when ddFc was oxidized by NOBF₄, as illustrated in FIG. 2. Therefore, oxidized ddFc⁺ was likely necessary for silver removal, but binding of the Ag(CN)₂⁻ to ddFc⁺ in DCM solvent may have resulted in decomposition of the silver complex to AgCN, which is insoluble in water. The reversible uptake isotherm for silver fit the Langmuir adsorption isotherm model (R²=0.97) with Qₘₐₓ of 83 mg/g and K_{eq} of 1.2 mM⁻¹, indicating that ddFc-silver binding did occur to an extent. When compared to dicyanoaurate adsorption isotherm illustrated in FIG. 10, uptake of anionic dicyanoargentate ([Ag(CN)₂]⁻) was unfavorable with ddFc, despite the structural similarities between cyano-silver and cyano-gold complexes. In a binary mixture of 5 mM KAu(CN)₂ and 5 mM KAg(CN)₂, the selectivity factor of gold adsorption with ddFc, relative to silver, was 18.5:1, as illustrated in FIG. 35, confirming the favorability of gold-ddFc binding over silver.

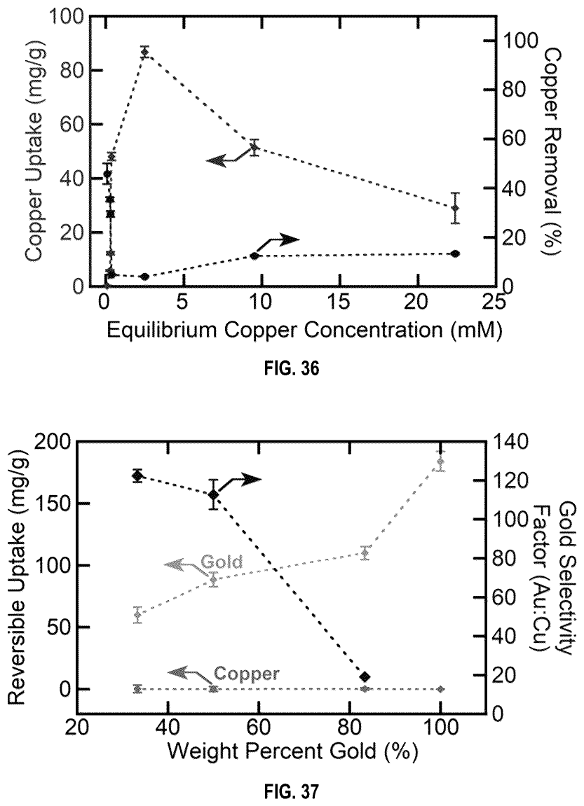

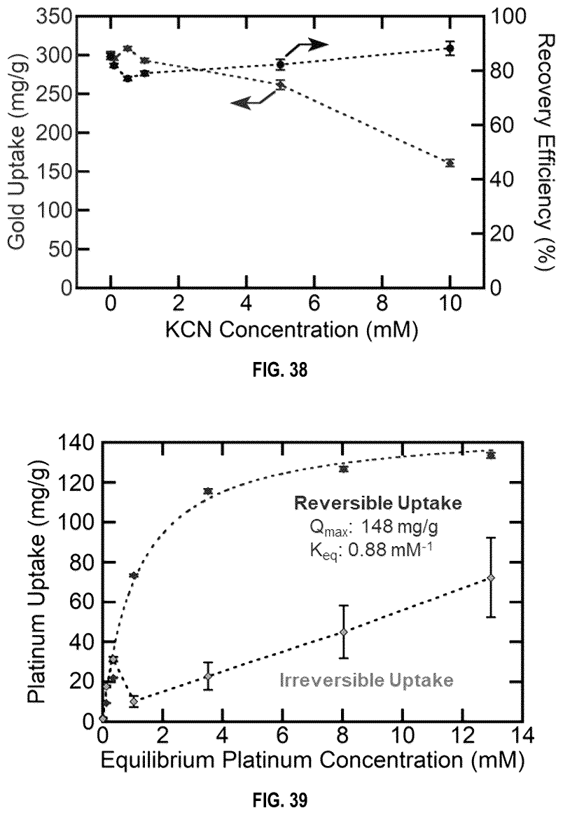

Copper uptake with ddFc was substantially irreversible, with an average recovery efficiency of 15% and a maximum reversible uptake of 6.4 mg_{Cu}/g_{ddFc} at 10 mM K₂Cu(CN)₃, as illustrated in FIG. 36. Therefore, copper binding to ddFc⁺ is highly unfavorable. Like silver and gold, control adsorption experiments indicated that copper extraction to DCM occurred only when NOBF₄-oxidized ddFc was present, as illustrated in FIG. 2, indicating that copper did react with ddFc⁺ to a minor degree. Binary adsorption of 5 mM gold and 5 mM copper resulted in a high gold selectively factor of 113:1 relative to copper, as illustrated in FIG. 37. For stability of the cyano-copper complex, 5 mM KCN was present in the aqueous leach solution, and therefore, the effect of excess free cyanide (KCN) in the metal leach was analyzed with 5 mM KAu(CN)₂ as the target metal. The uptake of gold was observed to progressively decrease from 301 to 165 mg_{Au}/g_{ddFc} as the concentration of KCN increased from 0 to 10 mM, but gold recovery efficiency remained consistently high with an average of 90%, as illustrated in FIG. 38. Free cyanide (CN⁻) may be oxidized to (CN)₂ above a formal potential of 0.35 V vs. Ag/AgCl. Therefore, excess free cyanide likely resulted in premature reduction of ddFc⁺, with a formal potential of 0.41 V vs. Ag/AgCl, resulting in lower gold uptake. However, a great excess (>10 mM) of free cyanide was required to appreciable reduce ddFc⁺, and 5 mM of free KCN resulted in only a 13% loss in gold uptake. Therefore, the free cyanide concentration of a metal leach solution should be less than 5 mM.

### VII. Platinum Group Metal (PGM) Recovery Performance.

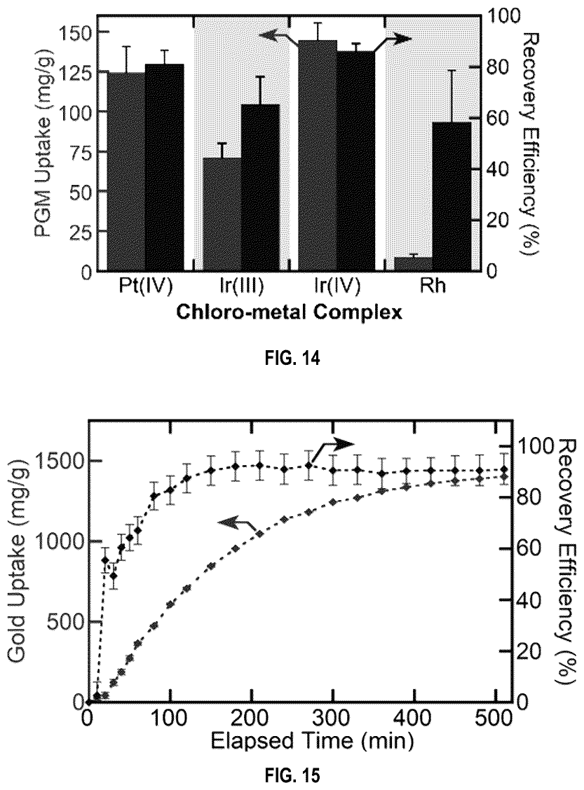

Extraction of various anionic chloro-complexes of platinum group metals (PGMs) were tested with an example of an electrified liquid-liquid extraction system of the present disclosure in which the compound of formula (I) is ddFc. The anionic chloro-complexes tested included [Pt(IV)Cl₆]²⁻, [Ir(III)Cl₆]³⁻, [Ir(IV)Cl₆]²⁻, and [Rh(III)Cl₆]³⁻. For each species of the anionic chloro-complexes, 5 mM of aqueous PGM was adsorbed into DCM by 2 mM ddFc oxidized with equimolar NOBF₄, and subsequently the PGM was released to a new aqueous reduction stream containing 10 mM sodium ferrocyanide for complete, reversible extraction. Pt(IV) and Ir(IV) demonstrated the highest uptakes (124 mg_{Pt}/g_{ddFc} and 144 mg_{Ir}/g_{ddFc}, respectively), and the highest separation reversibilities of 81 and 86%, respectively, as illustrated in FIG. 14. The uptake of Ir(III) was only 71 mg_{Ir}/g_{ddFc}, which is half of the uptake of Ir(IV), and virtually no Rh(III) was adsorbed by ddFc, as illustrated in FIG. 14. The uptakes illustrated in FIG. 14 suggest that ddFc-enabled extraction more favorably adsorbs anionic metal complexes of larger atomic size, and that uptake decreases as the formal charge of the target anion becomes more negative, or, in other words, [Au(CN)₂]⁻>[PtCl₆]²⁻>[IrCl₆]³⁻.

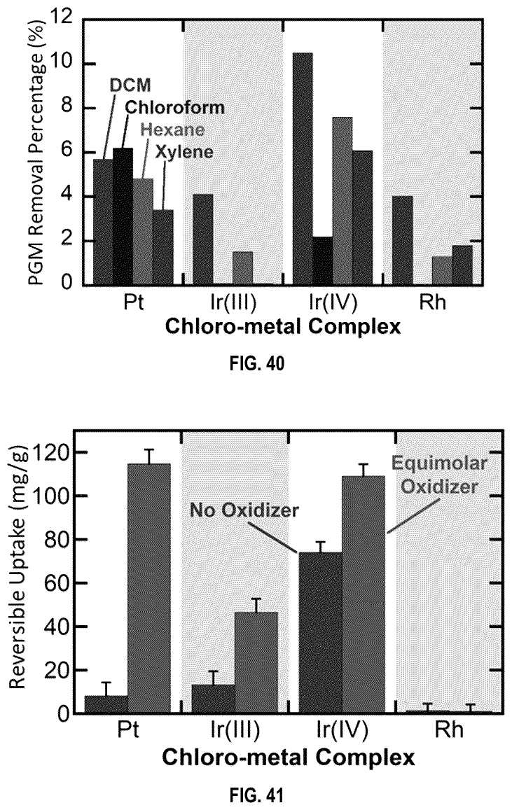

A reversible uptake isotherm was prepared for chloroplatinic acid, and the Langmuir adsorption isotherm model was fit (R²=0.988) with Qₘₐₓ=148 mg/g and K_{eq}=0.88 mM⁻¹, as illustrated in FIGS. 10 and 39. Aqueous PGMs were mixed with pure solvents, including DCM, chloroform, hexane, and xylene, to understand background uptake to due to PGM-organic solubility, and only 4.1% of aqueous PGM salts leached to the organic DCM phase, as illustrated in FIG. 40. Overall, Pt(IV) and Ir(IV) were the most soluble in organic solvent, compared to Ir(III) and Rh(III), and similarly to uptake results, the trend was likely due to the lower −2 formal charge of [PtCl₆]²⁻ and [IrCl₆]²⁻. The uptake of 5 mM aqueous PGM salts with ddFc (without oxidizing agent) was carried out, and despite no NOBF₄ oxidizing agent, 75 mg/g of Ir(IV) was reversibly adsorbed, while all other PGM salts demonstrated negligible uptake. The reversible uptake of each PGM species with and without NOBF₄ oxidizing agent was demonstrated in FIG. 41. Iridium had a reversible redox couple IrCl₆²⁻/IrCl₆³⁻ with a formal potential of 0.65 V vs. Ag/AgCl, which allowed Ir(IV) to spontaneously oxidize ddFc to ddFc⁺ (E⁰=0.41 V vs. Ag/AgCl) and simultaneously bind the reduced Ir(III) to oxidized ddFc⁺. Therefore, selective capture of H₂IrCl₆ was possible by use of an example of the electrified liquid-liquid extraction system including ddFc as the compound of formula (I), and requiring no energy or material consumption.

### VIII. Continuous Gold Extraction.

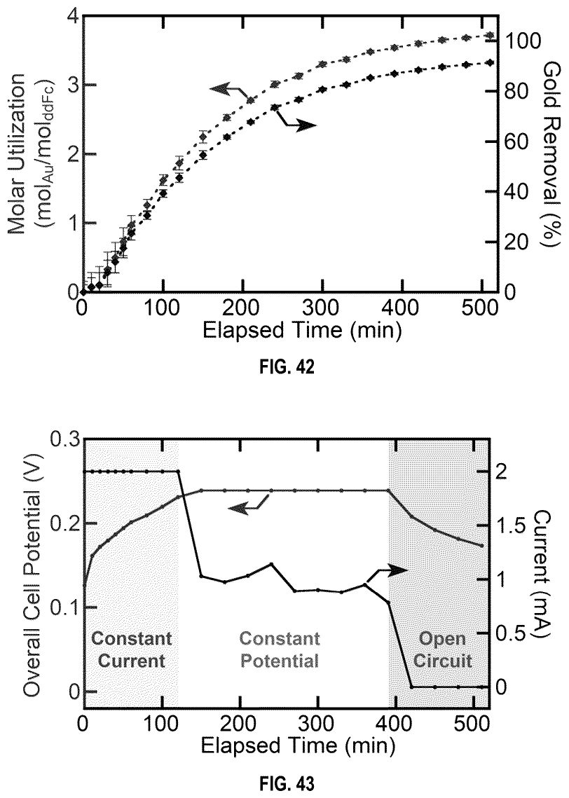

A 20 mL/min stream of 5 mM KAu(CN)₂ was continuously extracted and purified without chemical consumption by an example of an electrified liquid-liquid extraction system 100 illustrated in FIG. 1. 20 mL of 2 mM ddFc in DBM organic solvent was continuously cycled through organic adsorbent loop 102 at 10 mL/min. In the oxidation column 106, ddFc would be oxidized to active adsorbent, ddFc⁺, by a closed aqueous oxidant loop 102 of 10 mM I₃⁻ flowing at 20 mL/min, where the reduced iodide would be electrochemically regenerated. After the oxidation to ddFc⁺, the organic adsorbent phase entered leach column 110, where 92% of aqueous gold was selectively extracted from the aqueous leach stream, as illustrated in FIG. 42. An impressive gold uptake of 1402 mg/g_{ddFc} was achieved over the span of 8 hours, as illustrated in FIG. 15.

Following gold uptake, the gold-laden organic phase passed through reduction column 114, where a 10 mL closed aqueous loop of 10 mM sodium ferrocyanide (20 mL/min) simultaneously reduced ddFc⁺ and extracted the unbound [Au(CN)₂]⁻ anion into aqueous reductant loop 112. The ddFc was cycled for reuse in oxidation column 106 to repeat the liquid-liquid extraction process in closed organic adsorbent loop 102 that may not consume adsorbent or solvent. All extracted gold was ultimately sequestered to the closed aqueous reductant loop 112, where the gold was concentrated. 91% of the extracted gold was reversibly recovered, as illustrated in FIG. 15, and up-concentrated by a factor of 2. 3.7 gold molecules were extracted per ddFc molecule, proving that ddFc adsorbent was recycled and reused, as illustrated in FIG. 42.

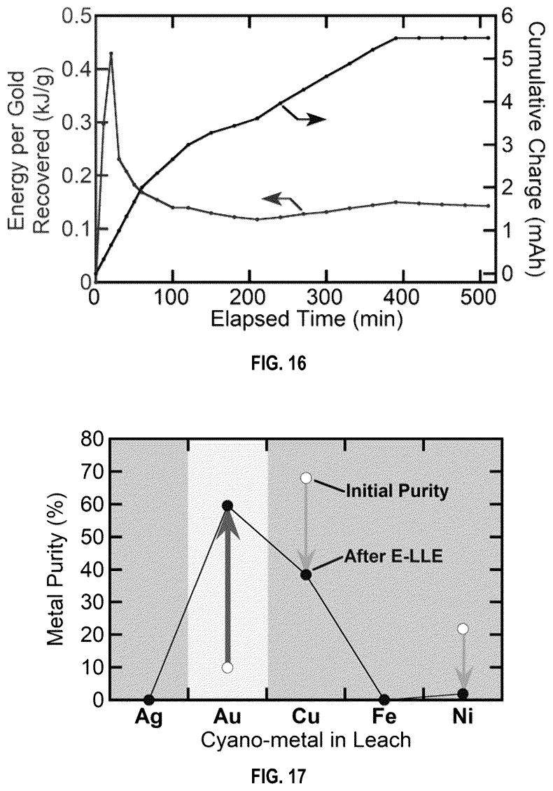

The spent iodine oxidizing agent and ferrocyanide reducing agent were electrochemically regenerated in flow cell 116 separated by ion exchange membrane 108 with 4×4×0.3 cm carbon felt electrodes, which is a similar configuration to a redox flow battery. Flow cell 116 was operated with a constant current of 2 mA until a two-electrode potential of 0.23 V (Eₒₓ−Eᵣₑd) was reached, and the potential was held constant thereafter, as illustrated in FIG. 43. Due to the low operating potential <0.23 V and operating current <2 mA, coupled with the high molar utilization of ddFc (3.7 mol Au/ddFc), energy consumption per gold recovered was 0.143 kJ/g_{Au}, as illustrated in FIG. 16. The example of the electrified liquid-liquid extraction system of the present disclosure had a total utility cost of $2.89 per metric ton of gold recovered with no materials consumed, and 3 mW power from a single 5 cm² pocket calculator solar cell would recover 2.2 grams of pure gold per day.

IX. Applied Gold Recovery from Local E-Waste.

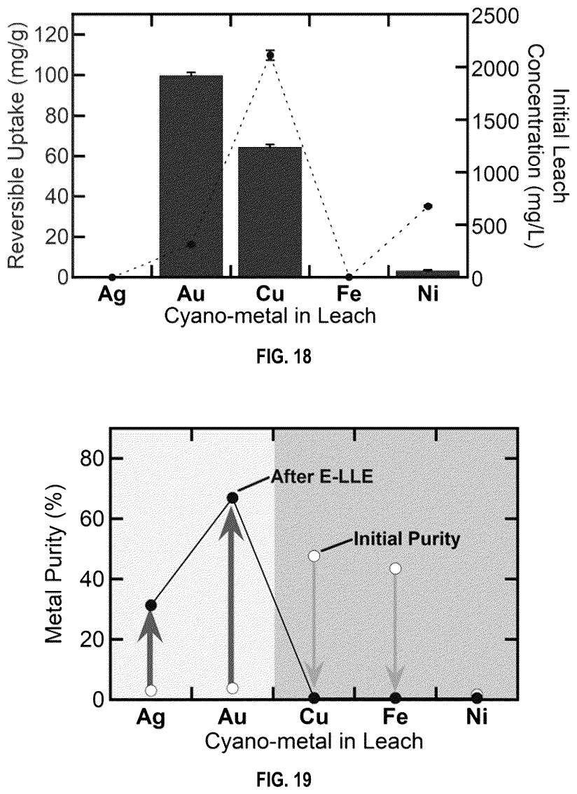

310 grams of locally sourced electronic waste, in the form of DDR3 computer RAM modules, were added to 1 L of 10 mM KCN to leach the surface gold and other metals. The leach process was optimized to minimize chemical consumption. After 24 hours of aerated leaching, the e-waste leach solution contained 2.11 g/L copper, 676.53 mg/L nickel, 309.89 mg/L gold, 1.94 mg/L iron, and 0.13 mg/L silver as the 5 major constituents, as illustrated in FIG. 18, and the leach solution had a pH of 10. Without any further processing of the leach solution, the gold was recovered by use of an example of the electrified liquid-liquid extraction system of the present disclosure, with 2 mM ddFc with a gold uptake of 109 mg/g. Compared to the pure gold adsorption isotherm, gold uptake from e-waste leach was 30% lower, and the loss in uptake may have been due to the 29-fold molar excess of competing copper and nickel ions in the leach solution. When the organic phase ddFc⁺ was reduced with 10 mM of aqueous ferrocyanide, 91.6% of adsorbed gold was released into the aqueous reducing phase, and the gold was successfully purified from 9.9% to a final gold purity of 59.6% in a single adsorption pass, as illustrated in FIG. 17, with a gold selectivity factor of 13.3:1 relative to Cu, Ni, Fe, and Ag. Thus, selective recovery and purification of gold is possible with real-world e-waste leach solutions using ddFc as the compound of formula (I) in an example of the electrified liquid-liquid extraction system of the present disclosure.

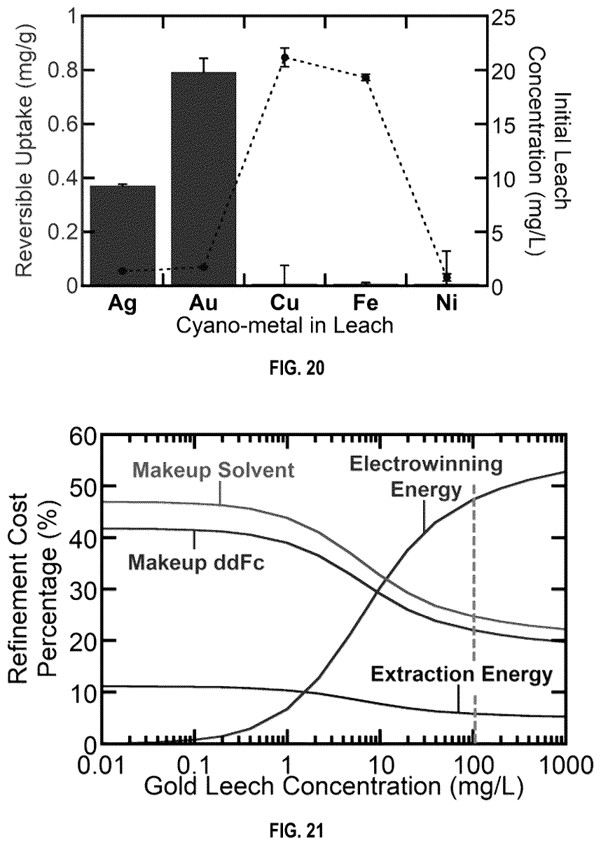

Gold ore leach solution was simulated, resulting in a solution containing 21.17 mg/L Cu, 19.31 mg/L Fe, 1.73 mg/L Au, 1.37 mg/L Ag, and 0.78 mg/L Ni. After electrified liquid-liquid extraction in an example of a system of the present disclosure, including 2 mM ddFc, 98.3% of the gold contained in the leach solution was extracted, as illustrated in FIG. 19, with a relative selectivity factor of 50.1. The purity of gold increased from 3.9% in the leach to a final gold purity of 67.0%, as illustrated in FIG. 20.

### X. Technoeconomic Analysis.

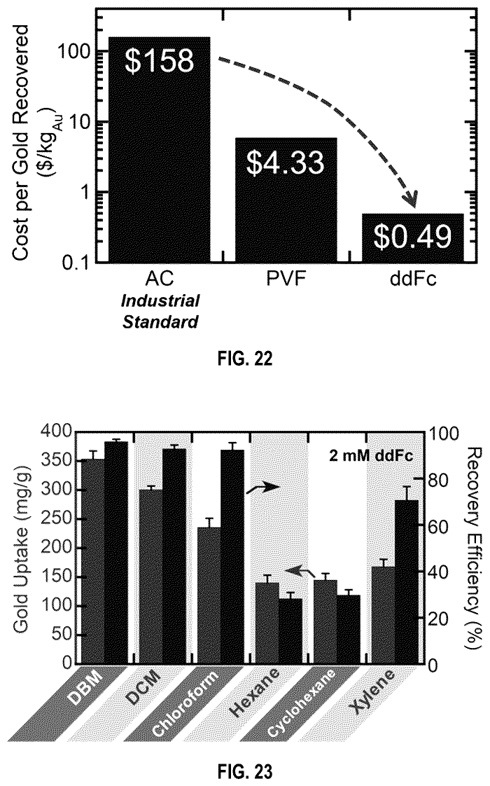

The technoeconomics of an example of an electrified liquid-liquid extraction system of the present disclosure were evaluated and compared to: the industrial standard technology, activated carbon-based CIP; and PVF-CNT electrode adsorbent. The scope of this technoeconomic analysis covered all processing of the gold stream following the cyanide leaching stage, including the recovery and concentration of gold in solution and gold electrodeposition. From a basis of 4000 L/min leach solution flow containing 50% gold and silver at a concentration ranging from 0.006 to 1000 mg/L gold, the energy and materials costs were estimated for each adsorbent method: CIP, PVF electrosorption, and electrified liquid-liquid extraction, utilizing a 6 absorbing unit cascade model that recovered 99.9% of gold from the leach solution. For an example of the electrified liquid-liquid extraction system of the present disclosure, the cost to make up the 0.1% of solvent, and 0.5% of compound of formula (I) lost to the aqueous tailings stream was the dominant cost factor at an initial gold leach concentration below 10 mg/L (low-grade ore mining conditions), justifying the selection of solvent and adsorbent with high immiscibility in water, as illustrated in FIG. 21. At gold feed concentration above 10 mg/L, the energy cost of gold electrodeposition was dominant, and the energy cost of continuously extracting gold with compound of formula (I) was lowest, making up 10% of the total operational cost of compound of formula (I) due to the low 0.86 kJ/g_{Au} energy consumption of electrified liquid-liquid extraction. At a gold feed concentration of 100 mg/L, an example of an electrified liquid-liquid extraction system of the present disclosure cost $0.49 per kilogram of gold recovered, compared to $4.33 for PF electrosorption, and $158 for conventional AC-based CI, as illustrated in FIG. 22. Therefore, the example of the electrified liquid-liquid extraction system of the present disclosure was 322 times cheaper than the current industrial process—CIP—by consuming over 99.9% less energy, and 99.4% less chemical materials. In addition, the selectivity of electrified liquid-liquid extraction resulted in 99.2% pure gold after 6 adsorption passes, while CIP resulted in 50% gold requiring further costly processing. Electrified liquid-liquid extraction is a true, fully continuous process—unlike CIP—with a simplified process design, and reduced process size, technician count, and system downtime. Therefore, the example of the continuous electrified liquid-liquid extraction system of the present disclosure including compound of formula (I) provides highly economic and sustainable gold recovery.

The examples of the electrified liquid-liquid extraction system of the present disclosure demonstrate highly efficient molar utilization of compound of formula (I) of >89%, and retain >99% gold recovery efficiency. Coupled with reducing and oxidizing redox mediators with a low 0.23 V overall working potential, the energy consumption of the system is more than 3 orders of magnitude lower than conventional CIP (E_{(I)}=0.86 kJ/g_{Au}, E_{CIP}=2046 kJ/g_{Au}), and the compound of formula (I) is highly selective to gold (>20:1) and capable of simultaneous gold purification to over 99% and up-concentration by a factor of 16. The system is successful at purifying gold from real electronic waste and mining leach solution including over 39-fold excess metals. The selectivity of compound of formula (I) to precious metals platinum, iridium, and rhodium is thought to be driven by charge transfer to bulky anionic species with a distributed negative formal charge. Dicyanoaurate has the highest binding affinity to a compound of formula (I). The system operates fully continuously, simultaneously extracting and releasing gold autonomously, to achieve over 1500 mg/g uptake, over 90% gold removal, and 91% gold recovery efficiency, demonstrating greater simplicity and performance of gold recovery than other methods.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to an electrified liquid-liquid extraction system, comprising: an organic adsorbent loop, through which flows a solution of an alkyl-substituted ferrocene compound in an organic solvent, the organic adsorbent loop comprising, in a direction of flow of the solution, an oxidation solvent extraction column, a leach solvent extraction column, and a reduction solvent extraction column; an aqueous oxidant loop, through which flows an aqueous oxidant solution comprising an oxidizing agent, the aqueous oxidant loop comprising, in a direction of flow of the aqueous solution of the oxidizing agent, the oxidation solvent extraction column and an anode of a flow cell; an aqueous reductant loop, through which flows an aqueous reductant solution comprising a reducing agent, the aqueous reductant loop comprising, in a direction of flow of the aqueous solution of the reducing agent, the reduction solvent extraction column and a cathode of the flow cell; a leach stream loop, through which flows a leach solution, the leach stream loop comprising the leach solvent extraction column; and the flow cell, comprising an ion exchange membrane between the cathode and the anode.

A second aspect relates to the system of aspect 1, wherein the alkyl-substituted ferrocene compound is a compound of formula (I):

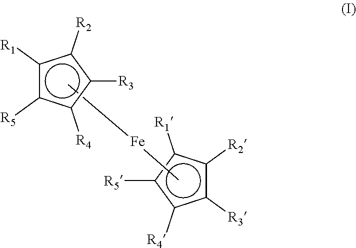

wherein each of R₁, R₂, R₃, R₄, R₅, R₁′, R₂′, R₃′, R₄′, and R₅′ is independently hydrogen or (C₁-C₂₀)alkyl; and wherein at least one of R₁, R₂, R₃, R₄, R₅, R₁′, R₂′, R₃′, R₄′, and R₅′ is (C₁-C₃₀)alkyl.

A third aspect relates to the system of aspect 1 or 2, wherein the alkyl-substituted ferrocene compound is selected from the group consisting of: 1,1′-diethylferrocene, octylferrocene, 1,1′-didodecylferrocene, and any combination thereof.

A fourth aspect relates to the system of any preceding aspect, wherein the alkyl-substituted ferrocene is 1,1′-didodecylferrocene.

A fifth aspect relates to the system of any preceding aspect, wherein the organic solvent comprises a halogen.

A sixth aspect relates to the system of any preceding aspect, wherein the organic solvent is dibromomethane, dichloromethane, or a combination thereof.

A seventh aspect relates to the system of any preceding aspect, wherein the oxidizing agent is selected from the group consisting of NOBF₄, Na₂CrO₄, Na₃VO₄, FeCl₃, and NaI₃.

An eighth aspect relates to the system of any preceding aspect, wherein the oxidizing agent is NOBF₄.

A ninth aspect relates to the system of aspect 8, wherein a molarity of aqueous NOBF₄ in the aqueous oxidant solution is greater than a molarity of the alkyl-substituted ferrocene compound in the solution.

A tenth aspect relates to the system of aspect 8, wherein a molar ratio of NOBF₄ to the alkyl-substituted ferrocene compound is about 1:1.

An eleventh aspect relates to the system of aspect 8, wherein a pH of the aqueous oxidant solution is about 2.

A twelfth aspect relates to the system of aspects 1 to 7, wherein the oxidizing agent is NaI₃.

A thirteenth aspect relates to the system of aspect 12, wherein a molar ratio of NaI₃ to the alkyl-substituted ferrocene compound is about 1.25.

A fourteenth aspect relates to the system of any preceding aspect, wherein the reducing agent is selected from the group consisting of Na₂S₂O₅, NaS₂O₃, ascorbic acid, and Na₄Fe(CN)₆.

A fifteenth aspect relates to the system of any preceding aspect, wherein the reducing agent is Na₄Fe(CN)₆.

A sixteenth aspect relates to the system of aspect 15, wherein a molar of Fe(CN)₆⁴⁻ to the alkyl-substituted ferrocene compound is about 1:1.

A seventeenth aspect relates to the system of aspect 15, wherein a molar ratio of Fe(CN)₆⁴⁻ to the alkyl-substituted ferrocene compound is greater than 1:1.

An eighteenth aspect relates to the system of any preceding aspect, wherein the leach solution comprises an ionic species comprising gold, platinum, iridium, palladium, silver, rhodium, and any combination thereof.

A nineteenth aspect relates to the system of any preceding aspect, wherein the leach solution comprises a gold anionic species at a molarity of less than or equal to about 0.2 mM.

A twentieth aspect relates to the system of any preceding aspect, wherein a volume ratio of the leach solution to the aqueous reductant solution is about 16:1.

A twenty-first aspect relates to a method of recovering a metal from a leach solution, comprising: cycling a solution of an alkyl-substituted ferrocene compound in an organic solvent sequentially through an oxidation solvent extraction column, a leach solvent extraction column, and a reduction solvent extraction column in an organic adsorbent loop; oxidizing the alkyl-substituted ferrocene compound in the oxidation solvent extraction column to provide an oxidized alkyl-substituted ferrocene compound; adsorbing an anionic species of the metal ion from the leach solution to the oxidized alkyl-substituted ferrocene compound in the leach solvent extraction column to provide a complex of the anionic species and the oxidized alkyl-substituted ferrocene compound; and reducing the oxidized alkyl-substituted ferrocene compound to provide the alkyl-substituted ferrocene compound in the reduction solvent extraction column, the anionic species transferred to an aqueous reductant solution in the reduction solvent extraction column.

A twenty-second aspect relates to the method of aspect 21, wherein the cycling is performed continuously.

A twenty-third aspect relates to the method of aspect 21 or 22, wherein the alkyl-substituted ferrocene compound is a compound of formula (I):

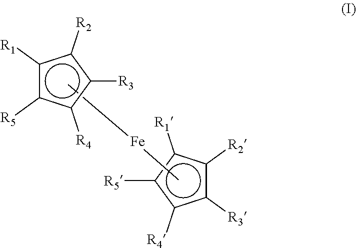

wherein each of R₁, R₂, R₃, R₄, R₅, R₁′, R₂′, R₃′, R₄′, and R₅′ is independently hydrogen or (C₁-C₃₀)alkyl; and wherein at least one of R₁, R₂, R₃, R₄, R₅, R₁′, R₂′, R₃′, R₄′, and R₅′ is (C₁-C₃₀)alkyl.

A twenty-fourth aspect relates to the method of aspects 21 to 23, wherein the alkyl-substituted ferrocene compound is selected from the group consisting of: 1,1′-diethylferrocene, octylferrocene, 1,1′-didodecylferrocene, and any combination thereof.

A twenty-fifth aspect relates to the method of aspects 21 to 24, wherein the alkyl-substituted ferrocene is 1,1′-didodecylferrocene.

A twenty-sixth aspect relates to the method of aspects 21 to 25, wherein the organic solvent comprises a halogen.

A twenty-seventh aspect relates to the method of aspects 21 to 26, wherein the organic solvent is dibromomethane, dichloromethane, or a combination thereof.

A twenty-eighth aspect relates to the method of aspects 21 to 27, wherein the oxidizing comprises cycling an aqueous oxidant solution comprising an oxidizing agent through an aqueous oxidant loop, the aqueous oxidant loop comprising the oxidation solvent extraction column.

A twenty-ninth aspect relates to the method of aspect 28, wherein the oxidizing agent is selected from the group consisting of NOBF₄, Na₂CrO₄, Na₃VO₄, FeCl₃, and NaI₃.

A thirtieth aspect relates to the method of aspect 28, wherein the oxidizing agent is NOBF₄.

A thirty-first aspect relates to the method of aspect 30, wherein a molarity of aqueous NOBF₄ in the aqueous oxidant solution is greater than a molarity of the alkyl-substituted ferrocene compound in the solution.

A thirty-second aspect relates to the method of aspect 30, wherein a molar ratio of NOBF₄ to the alkyl-substituted ferrocene compound is about 1:1.

A thirty-third aspect relates to the method of aspect 30, wherein a pH of the aqueous oxidant solution is about 2.

A thirty-fourth aspect relates to the method of aspect 28, wherein the oxidizing agent is NaI₃.

A thirty-fifth aspect relates to the method of aspect 34, wherein a molar ratio of NaI₃ to the alkyl-substituted ferrocene compound is about 1.25:1.

A thirty-sixth aspect relates to the method of aspects 21 to 35, wherein the reducing comprises cycling an aqueous reductant solution comprising a reducing agent through an aqueous reductant loop, the aqueous reductant loop comprising the reduction solvent extraction column.

A thirty-seventh aspect relates to the method of aspect 36, wherein the reducing agent is selected from the group consisting of Na₂S₂O₅, NaS₂O₃, ascorbic acid, and Na₄Fe(CN)₆.

A thirty-eighth aspect relates to the method of aspect 36, wherein the reducing agent is Na₄Fe(CN)₆.

A thirty-ninth aspect relates to the method of aspect 38, wherein a molar ratio of Fe(CN)₆⁴⁻ to the alkyl-substituted ferrocene compound is about 1:1.

A fortieth aspect relates to the method of aspect 38, wherein a molar ratio of Fe(CN)₆⁴⁻ to the alkyl-substituted ferrocene compound is greater than 1:1.

A forty-first aspect relates to the method of aspects 21 to 40, wherein the adsorbing comprises cycling the leach solution through a leach stream loop comprising the leach solvent extraction column.

A forty-second aspect relates to the method of aspects 28 to 35, further comprising regenerating the oxidizing agent at an anode of a flow cell, the aqueous oxidant loop comprising the anode downstream of the oxidation solvent extraction column.

A forty-third aspect relates to the method of aspects 36 to 40, further comprising regenerating the reducing agent at a cathode of a flow cell, the aqueous reductant loop comprising the cathode downstream of the reduction solvent extraction column.

A forty-fourth aspect relates to the method of aspects 21 to 43, further comprising preparing the leach solution from electronic waste.

A forty-fifth aspect relates to the method of aspects 21 to 43, wherein the leach solution is prepared by heap leaching or dump leaching.

A forty-sixth aspect relates to the method of aspects 21 to 45, wherein a gold uptake from the leach solution was at least about 250 milligrams of gold per gram of the alkyl-substituted ferrocene compound.

A forty-seventh aspect relates to the method of aspects 21 to 46, wherein a gold recovery efficiency from the leach solution to the aqueous reductant solution is at least about 93%.

A forty-eighth aspect relates to the method of aspects 21 to 47, wherein a molar utilization is at least 90%.

A forty-ninth aspect relates to the method of aspects 21 to 48, wherein at least about 99% of the anionic species is transferred to the aqueous reductant solution.

A fiftieth aspect relates to the method of aspect 49, wherein the transfer of at least about 99% of the anionic reductant solution is in less than about 10 seconds.

In addition to the features mentioned in each of the independent aspects enumerated above, some examples may show, alone or in combination, the optional features mentioned in the dependent aspects and/or as disclosed in the description above and shown in the figures.

1. An electrified liquid-liquid extraction system, comprising:
an organic adsorbent loop, through which flows a solution of an alkyl-substituted ferrocene compound in an organic solvent, the organic adsorbent loop comprising, in a direction of flow of the solution, an oxidation solvent extraction column, a leach solvent extraction column, and a reduction solvent extraction column;
an aqueous oxidant loop, through which flows an aqueous oxidant solution comprising an oxidizing agent, the aqueous oxidant loop comprising, in a direction of flow of the aqueous solution of the oxidizing agent, the oxidation solvent extraction column and an anode of a flow cell;
an aqueous reductant loop, through which flows an aqueous reductant solution comprising a reducing agent, the aqueous reductant loop comprising, in a direction of flow of the aqueous solution of the reducing agent, the reduction solvent extraction column and a cathode of the flow cell;
a leach stream loop, through which flows a leach solution, the leach stream loop comprising the leach solvent extraction column; and
the flow cell, comprising an ion exchange membrane between the cathode and the anode.

2. The system of claim 1, wherein the alkyl-substituted ferrocene compound is a compound of formula (I): 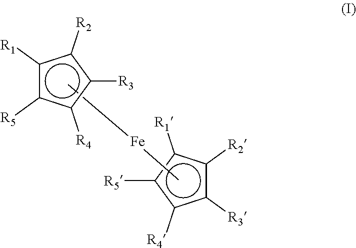
wherein each of R₁, R₂, R₃, R₄, R₅, R₁′, R₂′, R₃′, R₄′, and R₅′ is independently hydrogen or (C₁-C₃₀)alkyl; and
wherein at least one of R₁, R₂, R₃, R₄, R₅, R₁′, R₂′, R₃′, R₄′, and R₅′ is (C₁-C₃₀)alkyl.

3. The system of claim 1, wherein the alkyl-substituted ferrocene compound is selected from the group consisting of: 1,1′-diethylferrocene, octylferrocene, 1,1′-didodecylferrocene, and any combination thereof.

4. The system of claim 1, wherein the organic solvent is dibromomethane, dichloromethane, or a combination thereof.

5. The system of claim 1, wherein the oxidizing agent is selected from the group consisting of NOBF₄, Na₂CrO₄, Na₃VO₄, FeCl₃, and NaI₃.

6. The system of claim 1, wherein the reducing agent is selected from the group consisting of Na₂S₂O₅, NaS₂O₃, ascorbic acid, and Na₄Fe(CN)₆.

7. The system of claim 1, wherein the leach solution comprises an ionic species comprising gold, platinum, iridium, palladium, silver, rhodium, and any combination thereof.

8. The system of claim 1, wherein the leach solution comprises a gold anionic species at a molarity of less than or equal to 0.2 mM.

9. A method of recovering a metal from a leach solution, comprising:
cycling a solution of an alkyl-substituted ferrocene compound in an organic solvent sequentially through an oxidation solvent extraction column, a leach solvent extraction column, and a reduction solvent extraction column in an organic adsorbent loop;
oxidizing the alkyl-substituted ferrocene compound in the oxidation solvent extraction column to provide an oxidized alkyl-substituted ferrocene compound;
adsorbing an anionic species of the metal from the leach solution to the oxidized alkyl-substituted ferrocene compound in the leach solvent extraction column to provide a complex of the anionic species and the oxidized alkyl-substituted ferrocene compound; and
reducing the oxidized alkyl-substituted ferrocene compound to provide the alkyl-substituted ferrocene compound in the reduction solvent extraction column, the anionic species transferred to an aqueous reductant solution in the reduction solvent extraction column.

10. The method of claim 9, wherein the cycling is performed continuously.

11. The method of claim 9, wherein the alkyl-substituted ferrocene compound is a compound of formula (I): 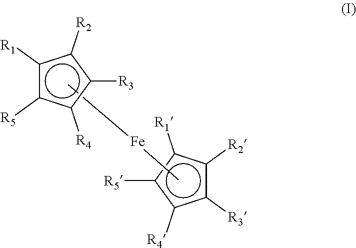
wherein each of R₁, R₂, R₃, R₄, R₅, R₁′, R₂′, R₃′, R₄′, and R₅′ is independently hydrogen or (C₁-C₃₀)alkyl; and
wherein at least one of R₁, R₂, R₃, R₄, R₅, R₁′, R₂′, R₃′, R₄,′ and R₅′ is (C₁-C₃₀)alkyl.

12. The method of claim 9, wherein the alkyl-substituted ferrocene compound is selected from the group consisting of: 1,1′-diethylferrocene, octylferrocene, 1,1′-didodecylferrocene, and any combination thereof.

13. The method of claim 9, wherein the organic solvent comprises a halogen.

14. The method of claim 9, wherein the oxidizing comprises cycling an aqueous oxidant solution comprising an oxidizing agent through an aqueous oxidant loop, the aqueous oxidant loop comprising the oxidation solvent extraction column.

15. The method of claim 9, wherein the oxidizing agent is selected from the group consisting of NOBF₄, Na₂CrO₄, Na₃VO₄, FeCl₃, and NaI₃.

16. The method of claim 9, wherein the adsorbing comprises cycling the leach solution through a leach stream loop comprising the leach solvent extraction column.

17. The method of claim 9, further comprising regenerating the oxidizing agent at an anode of a flow cell, the aqueous oxidant loop comprising the anode downstream of the oxidation solvent extraction column.

18. The method of claim 9, further comprising regenerating the reducing agent at a cathode of a flow cell, the aqueous reductant loop comprising the cathode downstream of the reduction solvent extraction column.

19. The method of claim 9, further comprising preparing the leach solution from electronic waste.

20. The method of claim 9, wherein the leach solution is prepared by heap leaching or dump leaching.
